(19) United States
(12) Patent Application Publication
(10) Pub. No.: US 2024/0367253 A1
(43) Pub. Date: Nov. 7, 2024

(54) STAINLESS STEEL AND COPPER JOINED BODY, METHOD OF PRODUCING SAME, AND STAINLESS STEEL AND COPPER JOINING METHOD

(71) Applicant: JFE STEEL CORPORATION, Chiyoda-ku, Tokyo (JP)

(72) Inventor: Shuji NISHIDA, Chiyoda-ku, Tokyo (JP)

(73) Assignee: JFE STEEL CORPORATION, Chiyoda-ku, Tokyo (JP)

(21) Appl. No.: 18/688,788

(22) PCT Filed: Sep. 21, 2022
(86) PCT No.: PCT/JP2022/035272

§ 371 Date: Mar. 4, 2024

(30) Foreign Application Priority Data
Oct. 5, 2021 (JP) 2021-164211

(51) Int. Cl. B23K 9/23; B23K 103/22; B32B 15/01; F16B 5/08

(52) U.S. Cl. CPC B23K 9/232; B32B 15/015; F16B 5/08; B23K 2103/22

(57) ABSTRACT

A stainless steel and copper joined body is provided. A fillet welded lap joint that is a joined portion of stainless steel and copper is formed at an end of the copper. The Cu/Fe ratio of the fillet welded lap joint is 2.3 or more. The fillet welded lap joint includes multiple welding points that are continuous in the welding direction. The average diameter Dₘₑₐₙ (mm) of the welding points and the copper thickness (mm) satisfy the relationship of the following Formula (1). The overlap ratio OR of welding points is 10% or more and 80% or less.

$$2 {t}^{0.5} \leq {D}_{mean} \leq 10 {t}^{0.5} \qquad ( 1 )$$

### TECHNICAL FIELD

The present disclosure relates to a stainless steel and copper joined body, a method of producing same, and a stainless steel and copper joining method.

### BACKGROUND

Stainless steel is a material that has excellent corrosion resistance and is widely used in various heat exchangers for automobiles and air conditioners as steel sheets and steel pipes or tubes. Further, copper is a material that has excellent thermal conductivity and is widely used in various heat exchangers as copper sheets and copper pipes or tubes.

In recent years, with the rising price of copper, there has been a trend to change the material of copper heat exchangers from copper to stainless steel. However, changing all materials from copper to stainless steel is difficult, and some copper components will remain. In such a case, a product is produced by combining stainless steel and copper components, and therefore stainless steel and copper must be joined at interfaces.

### CITATION LIST

### Patent Literature

PTL 1: JP 2003-523830 A (publication in Japan of WO 2001/062432 A1)

PTL 2: JP 2005-349443 A

### SUMMARY

### Technical Problem

Brazing is commonly used in the production of heat exchangers as a method for joining components. Brazing may be broadly classified into furnace brazing, in which members are heated in an atmospheric furnace for multiple-point simultaneous joining, and torch brazing, in which a joined portion is heated in air with a torch for single-point joining. Both methods may be used at different stages of product assembly.

Of these, particularly in torch brazing, materials to be joined are

exposed to high temperatures in the air. Therefore, when a material to be joined is stainless steel, a firm and dense oxide coating that hinders brazing tends to form on the surface of the stainless steel. Accordingly, in torch brazing stainless steel components to copper components, performing brazing at low temperatures is necessary.

Therefore, silver filler having a low melting point (melting point: about 600° C. to 700° C.) is commonly used for joining stainless steel and copper. However, silver filler is expensive. Further, proper torch brazing requires skill in operation. Further, an oxide coating may form on the surface of stainless steel that hinders brazing even at about 600° C. Therefore, the use of flux is necessary for joining stainless steel and copper. However, the use of flux may reduce the corrosion resistance of stainless steel and copper. Further, cleaning to remove flux is labor intensive and leads to a reduction in productivity.

As such, there is a need to develop an alternative stainless steel and copper joining method to replace torch brazing using silver filler (hereinafter also referred to as silver brazing).

As an example stainless steel and copper joining method alternative to silver brazing, Patent Literature (PTL) 1 describes:
“a method for making a joint between copper or copper alloys and austenitic steel alloys, in which method in between the junction surfaces of the objects to be joined together, there is arranged at least one intermediate layer, so that the junction surfaces including their intermediate layers are pressed together, and at least the junction area is heated in order to create a diffusion joint, characterized in that there is brought a first intermediate layer (3) on the junction surface of the steel object (2) or against said surface, mainly in order to prevent the nickel loss from the steel object (2), and at least a second intermediate layer (4) on the junction surface of the copper object (1) or against said surface in order to activate the creation of a diffusion joint.”

Further, PTL 2 describes:
“a method of joining stainless steel and an object to be joined to the stainless steel, comprising: bringing a joining agent comprising solder and a joining metal into contact between the stainless steel and the object to be joined; and performing heat treatment while the joining agent is in contact with the stainless steel and the object to be joined.”

Here, the technique described in PTL 1 provides an intermediate layer such as Ni between the joining surfaces of stainless steel and copper. Further, the technique described in PTL 2 provides solder and a joining metal between the joining surfaces of stainless steel and copper. However, in products such as heat exchangers, contact with liquid and condensation occurs during use. Therefore, when stainless steel and copper joined bodies obtained by the techniques described in PTL 1 and 2 are applied to such products, there is a strong concern about contact corrosion of dissimilar metals due to a potential difference between the intermediate layer, solder, joint metal, copper, and stainless steel.

Thus, in joining stainless steel and copper, a highly reliable joining method as an alternative to silver brazing has not been established, and the development of such a joining method is currently desired.

The present disclosure was developed in view of the situation described above, as it would be helpful to provide a highly reliable stainless steel and copper joining method as an alternative to silver brazing, as well as a stainless steel and copper joined body and a method of producing same.

### Solution to Problem

In order to achieve the above, the inventors conducted extensive studies and came to the conclusion that use of welding is desirable as a highly reliable joining method as an alternative to silver brazing. However, welding stainless steel to copper has conventionally been considered difficult. One factor is cracking of the welded portion. The inventors studied the factors that cause this cracking of the welded portion and made the following discoveries.

In welding stainless steel and copper, when the stainless steel and copper melt and mix, the liquid phase separates into two phases: a first liquid phase that is mainly a stainless steel component and a second liquid phase that is mainly a copper component. The higher the amount of stainless steel melted relative to copper, the greater the proportion of the first liquid phase.

The solidification structure formed by cooling of the first liquid phase is brittle. Therefore, when the amount of the first liquid phase is large, internal stress is generated in the joined portion due to heat shrinkage rate difference between the stainless steel base metal and the copper base metal during cooling after welding. This internal stress causes the solidification structure of the first liquid phase to fracture. In other words, the internal stress leads to cracking of the welded portion. The internal stress tends to be particularly concentrated at welding start portions and end portions. Therefore, cracks in the welded portion are likely to form at welding start portions and end portions in particular. Further, cracks that occur often propagate and penetrate through the welded portion.

Based on the above discoveries, the inventors studied and focused on a difference in melting points between stainless steel and copper. That is, the melting point of stainless steel is about 1400° C. to 1500° C. In contrast, the melting point of copper is about 1100° C. Therefore, the inventors considered the following method. In addition to joint type being a fillet welded lap joint, an electrode is positioned on the copper side of the overlapping portion of the materials to be joined to actively melt only the copper. The molten copper being brought into contact with the surface of the stainless steel and allowed to solidify increases the proportion of copper in the fusion zone. In other words, the inventors studied suppression of formation of the first liquid phase mainly composed of a stainless steel component, in order to avoid cracking of the welded portion.

However, in this case, the molten copper did not spread on the surface of the stainless steel and was repelled, and sufficient strength of the joined portion (hereinafter also referred to as “joint strength”) was not obtained. The inventors further investigated the reason for this and found that a factor is the heat input to melt the copper raises the temperature of the stainless steel and a firm oxide coating forms on the surface of the stainless steel.

The inventors further studied methods of melting copper while suppressing the formation of oxide coating on the surface of stainless steel, and considered the use of welding methods that use inert gas as a shielding gas, in particular tungsten inert gas (TIG) welding.

However, TIG welding under typical conditions could not sufficiently suppress formation of a firm oxide coating on the surface of stainless steel. Further, in some cases, formation of the first liquid phase mainly composed of a stainless steel component could not be sufficiently suppressed.

The inventors further investigated and made the following discoveries.

In detail, TIG welding is used as the welding method, and an electrode is positioned on the copper side of the overlapping portion of the materials to be joined. Further dividing the heat input associated with welding into multiple localized and short-duration heat inputs is effective. In particular, it is effective to divide the welding into multiple heat inputs so that the following conditions (a) through (e) are satisfied and the relationship of the following Formula (3) between welding current I (A), welding time d (s), and copper thickness t (mm) is satisfied. This is able to suppress the amount of melting of the stainless steel and suppress formation of oxide coating on the surface of the stainless steel. As a result, sufficient joint strength is obtainable.
(a) Tilt angle α of the electrode in a perpendicular-to-welding direction: −10° to +60°

Here, the thickness direction of the materials to be joined is the reference angle (0°), and a side where a leading end of the electrode is pointed towards the copper side is +ve and a side where the leading end of the electrode is pointed towards the stainless steel side is −ve.
(b) Electrode height: more than 0 mm and 3.0 mm or less
(c) Each heat input position in the perpendicular-to-welding direction: 0 to +6×t (mm)

Here, t is the copper thickness (mm), an end of the copper at the surface of the overlapping portion is the reference position (0), the copper side is +ve and the stainless steel side is −ve.
(d) Distance interval in the welding direction between each heat input point: 20% or more to 90% or less of a diameter Dₖ₋₁ (mm) of a welding point formed by the immediately preceding heat input.
(e) Time interval between each heat input: 20% or more of the welding time (s) of the immediately preceding heat input.

$$500 \leq {I}^{1.5} \times {d}^{0.5} \times {t}^{- 1} \leq 3500 \qquad ( 3 )$$

Further, the inventors discovered that dividing the heat input for welding into multiple localized and short-duration heat inputs as described above disperses and reduces internal stress in the joined portion caused by heat shrinkage rate differences between the stainless steel base metal and the copper base metal during the cooling after welding, thereby providing the advantage of making cracking in the welded portion less likely to occur.

The inventors then further investigated and made the following discoveries.

In detail:
The welded portion is a fillet welded lap joint structure, the fillet welded lap joint is adjacent to the end of the copper in the perpendicular-to-welding direction, and the fillet welded lap joint includes multiple welding points that are continuous in the welding direction.
A Cu/Fe ratio of the fillet welded lap joint is 2.3 or more.
An average diameter Dₘₑₐₙ (mm) of the welding points of the fillet welded lap joint and the copper thickness t (mm) satisfy the following relationship

$$2 {t}^{0.5} \leq {D}_{mean} \leq 10 {t}^{0.5} \qquad ( 1 )$$

An overlap ratio OR of the welding points is 10% or more and 80% or less.

Accordingly, a stainless steel and copper joined body that has sufficient joint strength and is free from cracking at the welded portion is obtainable.

The present disclosure is based on these discoveries and further studies.

Primary features of the present disclosure are as follows.
1. A stainless steel and copper joined body, comprising stainless steel, copper, and a fillet welded lap joint of the stainless steel and the copper, wherein
the stainless steel and the copper each have a sheet or tubular shape,
the fillet welded lap joint is formed at an end portion of the copper and the fillet welded lap joint includes multiple welding points that are continuous in a welding direction,
a Cu/Fe ratio of the fillet welded lap joint is 2.3 or more,
average diameter Dₘₑₐₙ (mm) of the welding points and copper thickness t (mm) satisfy the relationship of the following Formula (1),

$$2 {t}^{0.5} \leq {D}_{mean} \leq 10 {t}^{0.5} \qquad ( 1 )$$

and an overlap ratio OR of the welding points is 10% or more and 80% or less.
2. The stainless steel and copper joined body according to 1, above, wherein Dₘₐₓ/Dₘᵢₙ, a ratio of maximum diameter Dₘₐₓ (mm) to minimum diameter Dₘᵢₙ (mm) of the welding points, satisfies the relationship of the following Formula (2):

$${D}_{max} / {D}_{min} \leq 1.4 . \qquad ( 2 )$$

3. A stainless steel and copper joining method, wherein overlapping stainless steel and copper materials to be joined are joined by fillet welding,
the fillet welding is TIG welding,
the TIG welding comprises
positioning an electrode at a copper side of the overlapping portion of the materials to be joined, and performing multiple heat inputs under conditions satisfying (a) to (e) below,
(a) a tilt angle α of the electrode in a perpendicular-to-welding direction: −10° to +60°
here, the thickness direction of the materials to be joined is the reference angle (0°), and a side where a leading end of the electrode is pointed towards the copper side is +ve and a side where the leading end of the electrode is pointed towards the stainless steel side is −ve,
(b) electrode height: more than 0 mm and 3.0 mm or less
(c) each heat input position in the perpendicular-to-welding direction: 0 to +6×t (mm)
here, t is the copper thickness (mm), an end of the copper at the surface of the overlapping portion is the reference position (0), the copper side is +ve and the stainless steel side is −ve,
(d) distance interval in the welding direction between each heat input point: 20% or more to 90% or less of a diameter Dₖ₋₁ (mm) of a welding point formed by the immediately preceding heat input,
(e) time interval between each heat input: 20% or more of the welding time (s) of the immediately preceding heat input,
and further, at each heat input, welding current I (A), welding time d (s), and the copper thickness t (mm) satisfy the relationship of the following Formula (3):

$$500 \leq {I}^{1.5} \times {d}^{0.5} \times {t}^{- 1} \leq 3500. \qquad ( 3 )$$

4. The stainless steel and copper joining method according to 3, above, wherein at least one of conditions (f) to (h) below are satisfied:
(f) for each heat input, the welding current of the heat input is the welding current of the immediately preceding heat input or less;
(g) for each heat input, the welding time of the heat input is the welding time of the immediately preceding heat input or less; and
(h) a long heat input time interval is provided between some heat inputs.
5. A method of producing a stainless steel and copper joined body by joining stainless steel and copper by the stainless steel and copper joining method according to 3 or 4, above.

### Advantageous Effect

According to the present disclosure, as an alternative to silver brazing, a highly reliable (in other words, sufficient joint strength and no cracking of the welded portion) stainless steel and copper joining method and a stainless steel and copper joined body are provided. Further, the stainless steel and copper joined body may be produced at a significantly lower cost than silver brazing, which is extremely advantageous when applied to stainless steel and copper interfaces of various equipment such as heat exchangers, for example.

### BRIEF DESCRIPTION OF THE DRAWINGS

In the accompanying drawings:

FIG. 1 is an example of an optical micrograph of a cross-section (Y-Z plane) perpendicular to the welding direction at a fillet welded lap joint of a stainless steel and copper joined body according to an embodiment of the present disclosure;

FIG. 2 is an example of an external photograph of a fillet welded lap joint of a stainless steel and copper joined body according to an embodiment of the present disclosure;

FIG. 3 is a schematic diagram illustrating an example of spatial arrangement of materials to be joined in a stainless steel and copper joining method according to an embodiment of the present disclosure; and

FIG. 4 is a schematic diagram illustrating an example of spatial arrangement of an electrode in a stainless steel and copper joining method according to an embodiment of the present disclosure.

### DETAILED DESCRIPTION

The following describes embodiments of the present disclosure.

### [1] Stainless Steel and Copper Joined Body

A stainless steel and copper joined body according to an embodiment of the present disclosure is,
a stainless steel and copper joined body, comprising stainless steel, copper, and a fillet welded lap joint of the stainless steel and the copper, wherein
the stainless steel and the copper each have a sheet or tubular shape,
the fillet welded lap joint is formed at an end portion of the copper (in other words, the fillet welded lap joint is adjacent to the end of the copper in a perpendicular-to-welding direction) and the fillet welded lap joint includes multiple welding points that are continuous in a welding direction,
a Cu/Fe ratio of the fillet welded lap joint is 2.3 or more,
average diameter Dₘₑₐₙ (mm) of the welding points and copper thickness t (mm) satisfy the relationship of the following Formula (1),

$$2 {t}^{0.5} \leq {D}_{mean} \leq 10 {t}^{0.5} \qquad ( 1 )$$

and an overlap ratio OR of the welding points is 10% or more and 80% or less.

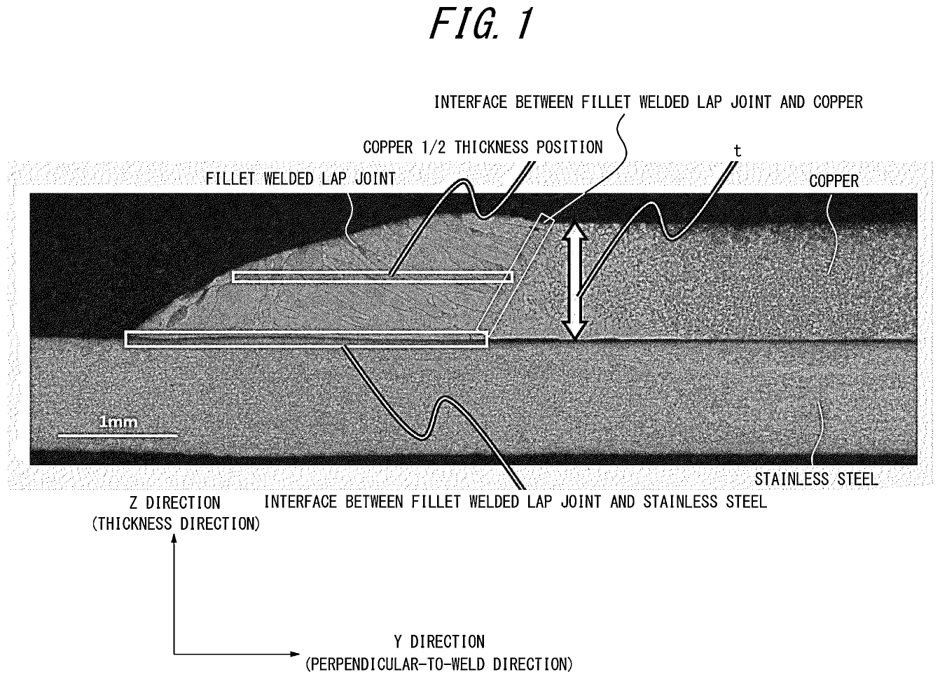

In FIG. 1 to FIG. 4, X direction, Y direction, and Z direction are defined as follows.
X direction: welding direction (may also be referred to as a copper edge direction along the interface between stainless steel and copper, and a longitudinal direction of the fillet welded lap joint).
Y direction: perpendicular-to-welding direction (perpendicular to the welding direction and perpendicular to a thickness direction (Z direction) as described below).
Z direction: the thickness direction of the joined body or the materials to be joined (the interface between stainless steel and copper is the reference position (0), with the copper side being +ve and the stainless steel side being −ve. May also be referred to as perpendicular to the interface between stainless steel and copper. Hereinafter, also referred to simply as the thickness direction)

FIG. 1 is an example of an optical micrograph of a cross-section (Y-Z plane) perpendicular to the welding direction at the fillet welded lap joint of a stainless steel and copper joined body according to an embodiment of the present disclosure.

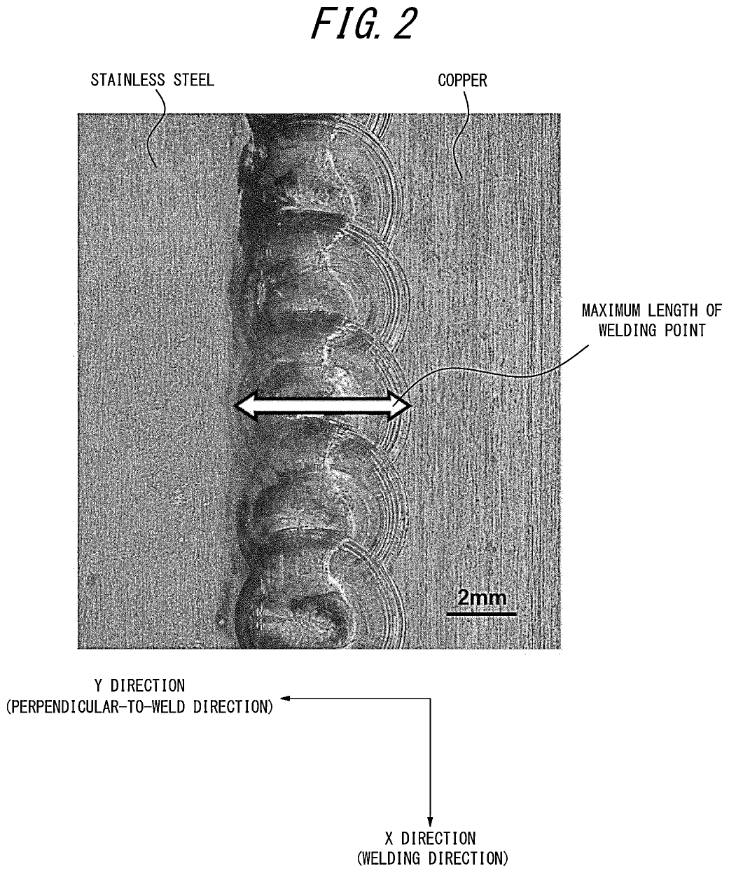

FIG. 2 is an example of an external photograph of the fillet welded lap joint of a stainless steel and copper joined body according to an embodiment of the present disclosure.

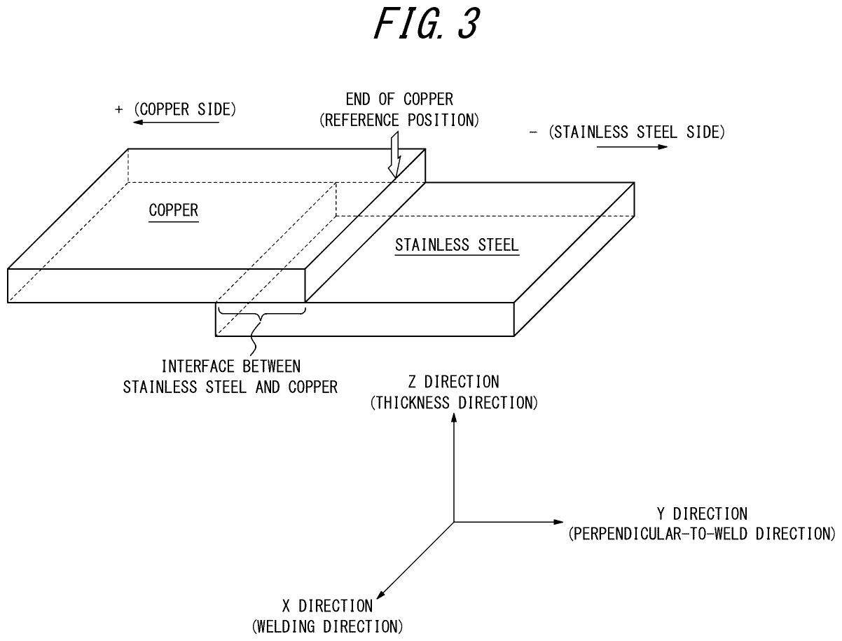

FIG. 3 is a schematic diagram illustrating an example of spatial arrangement of materials to be joined in a stainless steel and copper joining method according to an embodiment of the present disclosure.

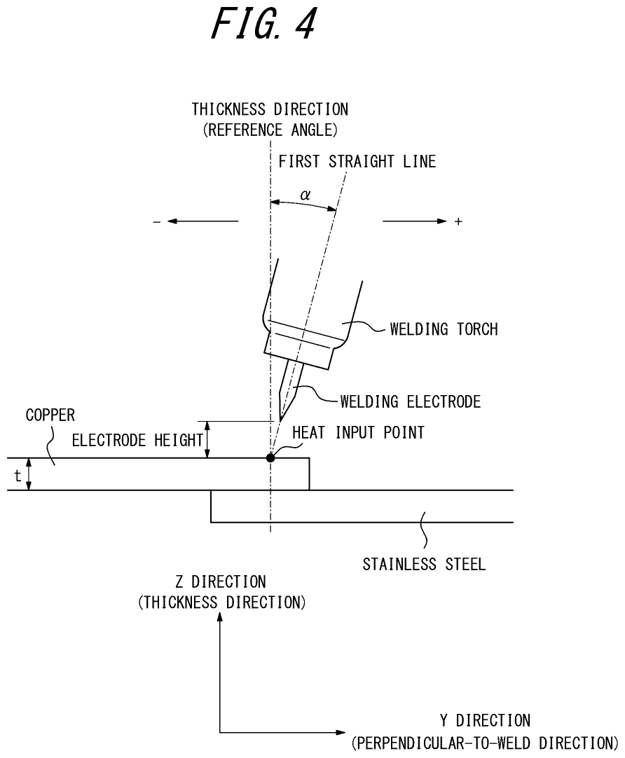

FIG. 4 is a schematic diagram illustrating an example of spatial arrangement of an electrode in a stainless steel and copper joining method according to an embodiment of the present disclosure.

### (1) Stainless Steel

The base metal is stainless steel, which may be in the shape of a sheet (stainless steel sheet) or a tube (stainless steel pipe or tube). The sheet shape here includes curved sheets (bent sheets) as well as flat sheets. The stainless steel thickness (sheet thickness or tube thickness) is not particularly limited. From the viewpoint of joinability, the stainless steel thickness is preferably 0.1 mm or more. Further, the stainless steel thickness is preferably 4.0 mm or less. The stainless steel thickness is more preferably 0.2 mm or more. The stainless steel thickness is even more preferably 0.3 mm or more. The stainless steel thickness is more preferably 2.0 mm or less. The stainless steel thickness is even more preferably 1.0 mm or less.

When the stainless steel used as the base metal is in the shape of a sheet, the size of the sheet is not particularly limited. For example, from the viewpoint of heat transfer and dissipation during welding, a length in the direction perpendicular to the welding direction is preferably 30 mm or more. When the base metal stainless steel is tubular in shape, the size of the tube (outer diameter and length) is not particularly limited. For example, from the viewpoint of heat transfer and dissipation during welding, the outer diameter of the tube is preferably four times the tube thickness (wall thickness) or more. The length of the tube is preferably 30 mm or more.

Further, the chemical composition of the stainless steel is not particularly limited and typical components of stainless steel suffice. For example, an iron-based alloy containing 10.5 mass % Cr or more and 50 mass % Fe or more. Examples include austenitic stainless steel sheets, austenitic-ferritic stainless steel sheets, ferritic stainless steel sheets, martensitic stainless steel sheets, precipitate hardened stainless steel sheets, and processed products thereof, as defined in Japanese Industrial Standard JIS G 4305:2021. Further examples include stainless steel sanitary pipes, stainless steel tubes for ordinary piping, stainless steel pipes for piping, stainless steel tubes for boilers and heat exchangers, and processed products thereof, as defined in JIS G 3447:2015, JIS G 3448:2016, JIS G 3459:2021, JIS G 3463:2019, and JIS G 3468:2021. Stainless steel sheets that have various surface finishes may be used, such as No. 2B finish (annealed and pickled skin pass finish), No. 2D finish (annealed and pickled finish), No. 4 finish (polished finish), No. 8 finish (mirror polished finish), BA finish (bright annealed finish), HL (hairline) finish, dull finish, embossing finish, and blast finish.

### (2) Copper

The base metal is copper, which may be in the shape of a sheet (copper sheet) or a tube (copper pipe or tube). The sheet shape here includes curved sheets (bent sheets) as well as flat sheets. The copper thickness (sheet thickness or tube thickness) is not particularly limited. From the viewpoint of joinability, the thickness of the stainless steel is preferably 0.1 mm or more. Further, the copper thickness is preferably 4.0 mm or less. The copper thickness is more preferably 0.3 mm or more. The copper thickness is even more preferably 0.5 mm or more. Further, the copper thickness is more preferably 2.0 mm or less. The copper thickness is even more preferably 1.0 mm or less.

When the copper used as the base metal is in the shape of a sheet, the size of the sheet is not particularly limited. For example, from the viewpoint of heat transfer and dissipation during welding, a length in the direction perpendicular to the welding direction is preferably 30 mm or more. When the base metal copper is tubular in shape, the size of the tube (outer diameter and length) is not particularly limited. For example, from the viewpoint of heat transfer and dissipation during welding, the outer diameter of the tube is preferably four times the tube thickness (wall thickness) or more. The length of the tube is preferably 30 mm or more.

Copper here includes not only so-called pure copper consisting of Cu and inevitable impurity, but also copper alloys containing 50 mass % Cu or more. Examples include various copper sheets and tubes, including oxygen-free copper, tough-pitch copper, phosphorous-deoxidized copper, tinned copper, brass, naval brass, white copper, nickel-tin copper, and processed products thereof, as defined in JIS H 3100:2018. Further examples include copper seamless tubes and welded tubes, and processed products thereof, as defined in JIS H 3300:2018 and JIS H 3320:2006. Copper sheets that have various surface finishes may be used, including HL (hairline) finish, satin finish, blast finish, and hammered finish.

### (3) Fillet Welded Lap Joint

In the stainless steel and copper joined body according to an embodiment of the present disclosure, the base metals, stainless steel and copper, are joined by a fillet welded lap joint, as illustrated in FIG. 1. Further, the fillet welded lap joint is adjacent to the end of the copper in the perpendicular-to-welding direction (in other words, the fillet welded lap joint is on the surface of the stainless steel). The fillet welded lap joint here does not include the heat-affected zone. The fillet welded lap joint is defined, for example, as follows. Observation by scanning electron microscopy (SEM) is performed on a cross-section sample as illustrated in FIG. 1, prepared in the manner described below, at a magnification of 100×. The interface (boundary) between the fillet welded lap joint and the stainless steel (base metal) and the interface (boundary) between the fillet welded lap joint and the copper (base metal) are determined, and the fillet welded lap joint is determined, from the cross-section shape, contrast difference of each microstructure, interface contrast, crystal grain size, and crystal grain anisotropy (aspect ratio) observed in a reflected electron image. For example, copper and stainless steel (as base metals) have parallel top and bottom surfaces in cross-section, and crystal grains are isotropic. In contrast, the fillet welded lap joint has top and bottom surfaces that are not parallel in cross-section, and crystal grains are long and narrow and highly anisotropic. Further, for example, at the interface between the copper and the fillet welded lap joint is an area of contrast change (hereinafter also referred to as a fusion line). Further, the interface between the stainless steel and the fillet welded lap joint is often different in contrast to the surrounding area, or there is a fusion line as described above. Further, as illustrated in FIG. 2, the fillet welded lap joint includes multiple welding points that are continuous in the welding direction. The number of welding points is not particularly limited as long as the number is 2 or more. The number of welding points is preferably 5 or more. In particular, the number of welding points is preferably 3 to 5 per 10 mm in the welding direction. Further, “continuous in the welding direction” means that a portion of each welding point overlaps with an adjacent welding point in the welding direction on the surface of the fillet welded lap joint, as illustrated in FIG. 2. In the stainless steel and copper joined body according to an embodiment of the present disclosure, it is particularly important to properly control the Cu/Fe ratio of the fillet welded lap joint and the size and arrangement of the welding points of the fillet welded lap joint.

### Cu/Fe Ratio of Fillet Welded Lap Joint: 2.3 or More

When the Cu/Fe ratio of the fillet welded lap joint is less than 2.3, a large amount of a first liquid phase mainly composed of a stainless steel component is generated, leading to cracking of the welded portion. The Cu/Fe ratio of the fillet welded lap joint is therefore 2.3 or more. The Cu/Fe ratio of the fillet welded lap joint is preferably 4.0 or more. An upper limit of the Cu/Fe ratio of the fillet welded lap joint is not particularly limited. For example, 100 or less is preferred.

Here, the Cu/Fe ratio of the fillet welded lap joint is measured at a copper ½ thickness position. For example, the Cu/Fe ratio of the fillet welded lap joint is calculated as follows. First, a cross-section sample in the thickness direction of the fillet welded lap joint (a sample with a cross-section in the plane perpendicular to the X direction that is the welding direction (Y-Z plane)), as illustrated in FIG. 1, is prepared with a mirror polish finish. The cross-section sample is then etched using picric acid hydrochloric acid (100 mL ethanol-1 g picric acid-5 mL hydrochloric acid). Next, the cross-section sample is observed by SEM at a magnification of 100×, and then analyzed by SEM energy dispersive X-ray spectroscopy (EDS). In this analysis, an EDS point scan is performed on the weld metal in the cross-section, that is, the solidification structure portion. The two elements to be analyzed are Fe and Cu. The Cu/Fe ratio is then determined from the mass ratio (mass %) of these two elements based on the following formula. The EDS scan points are 10 randomly selected points at the copper ½ thickness position (the position half the thickness of the copper distant from the interface between the fillet welded lap joint and the stainless steel, toward the fillet welded lap joint side). The Cu/Fe ratios measured at the points are then averaged to obtain the Cu/Fe ratio of one cross-section sample. This measurement is performed on five cross-section samples taken at random from the fillet welded lap joint, and the average Cu/Fe ratio of the cross-section samples obtained is considered to be the Cu/Fe ratio of the fillet welded lap joint.

$$Cu / Fe ratio = Cu / Fe$$

Here, Cu and Fe in the formula mean the mass ratio of Cu and Fe (mass %), respectively, as determined by the EDS point scans.

Average diameter Dₘₑₐₙ of welding points (mm):

$$2 {t}^{0.5} \leq {D}_{mean} \leq 10 {t}^{0.5} \qquad ( 1 )$$

The fillet welded lap joint includes multiple welding points that are continuous in the welding direction. It is essential that the average diameter Dₘₑₐₙ of the welding points satisfies the relationship of Formula (1), above, depending on the copper thickness t (mm). When the average diameter Dₘₑₐₙ of the welding points is less than 2t^{0.5}, the joining of stainless steel and copper in the fillet welded lap joint may become discontinuous, even when the overlap ratio OR of the welding points, as described below, is 10% or more. When the heat input during welding is insufficient for the copper thickness, the copper melts mainly only on a surface, and only a small amount of copper melts at a position directly below the heat input point, at a back face corresponding to the interface between stainless steel and the copper. In other words, the molten area of copper at the back face is excessively small compared to the molten area of copper on the surface. As a result, the copper fusion zone is discontinuous in the welding direction at the back face corresponding to the interface between stainless steel and copper. At such a discontinuity, the join between the stainless steel and copper in the fillet welded lap joint becomes discontinuous. In such a case, sufficient joint strength is unobtainable. Desired airtightness is also unobtainable. On the other hand, when the average diameter Dₘₑₐₙ of the welding points is greater than 10t^{0.5}, the heat input during welding is excessive for the copper thickness. Accordingly, formation of an oxide coating on the surface of the stainless steel is insufficiently suppressed, and sufficient joint strength becomes unobtainable. Further, formation of the first liquid phase mainly composed of a stainless steel component is increased, leading to cracking of the welded portion. The average diameter Dₘₑₐₙ of the welding points is therefore 2t^{0.5} or more and 10t^{0.5} or less. The average diameter Dₘₑₐₙ of the welding points is preferably 8t^{0.5} or less, from the viewpoint of joint strength.

Here, the average diameter Dₘₑₐₙ of the welding points is calculated as follows, for example. As illustrated in FIG. 2, the welding points of the fillet welded lap joint are observed from the direction perpendicular to the observation plane, in other words, from the Z direction, which is the thickness direction, using a 10× magnification loupe. For each welding point, the maximum length Lₖ in the perpendicular-to-welding direction is then measured. For each welding point, Lₖ is taken as the diameter Dₖ of the welding point. A caliper may be used to measure the maximum length of each welding point. The average value of the diameters Dₖ of all measured welding points is then taken as the average diameter Dₘₑₐₙ of the welding points. As illustrated in FIG. 2, the above measurement method is used because the outlines of welding points are partially lost due to subsequently formed welding points. Here, k is an integer from 1 to n indicating each welding point (each heat input), and n is the number of welding points (heat input count).

### Welding Points Overlap Ratio OR: 10% or More and 80% or Less

When the overlap ratio OR of the welding points (average overlap ratio) is less than 10%, even when the welding points are continuous on the surface of the fillet welded lap joint, the joining of stainless steel and copper becomes discontinuous on the back face corresponding to the interface between stainless steel and copper. Therefore, sufficient joint strength is unobtainable. Desired airtightness is also unobtainable. On the other hand, when the overlap ratio OR of the welding points exceeds 80%, the heat input count to the same location increases and the amount of heat input to effectively the same location becomes excessive. Accordingly, formation of an oxide coating on the surface of the stainless steel is insufficiently suppressed, and sufficient joint strength becomes unobtainable. Further, formation of the first liquid phase mainly composed of a stainless steel component is increased, leading to cracking of the welded portion. The overlap ratio OR of the welding points is therefore 10% or more and 80% or less. The overlap ratio OR of the welding points is preferably 30% or more. The overlap ratio OR of the welding points is preferably 60% or less.

The overlap ratio OR of the welding points is calculated by the following Formula (4).

$$OR ( \% ) = \{ 1 - A / ( {D}_{mean} \times N ) \} \times 100 \qquad ( 4 )$$

Here, A is the length in the welding direction of the fillet welded lap joint. N is the number of welding points included in the fillet welded lap joint. A may be measured using calipers, for example.

Depending on the shape, A may be determined, for example, as (D₁+Dₙ)/2+(B₂+B₃+ . . . Bₙ). Here, Bₖ is the shortest center-to-center distance (mm) between a kth welding point and a (k−1)th welding point formed immediately before it.

For example, when the joined body is a stainless steel pipe or tube and a copper pipe or tube (the stainless steel and the copper are tubular) and the welding points go around once, that is, the first and last welding points are adjacent (overlapping), A is the length of the entire circumference in the welding direction of the fillet welded lap joint. In this case, A may be determined, for example, as B₁+B₂+B₃+ . . . Bn. B₁ is the shortest center-to-center distance (mm) between the 1st and nth welding points.

Further, in the stainless steel and copper joined body according to an embodiment of the present disclosure, the structure described above helps prevents cracking of the welded portion and helps prevent join discontinuity at the overlap between the stainless steel and the copper, and therefore good airtightness, preferably 0.2 MPa or more, is obtainable.

Here, airtightness is measured as follows, for example.

### In the Case of a Joined Body of a Stainless Steel Sheet and a Copper Sheet (the Stainless Steel and the Copper are in the Shape of a Sheet)

A circle is drawn with a radius of 10 mm (diameter of 20 mm) (hereinafter also referred to as the reference circle) at a center portion of the fillet welded lap joint on the surface of the joined body (the surface on the side where the fillet welded lap joint is located) and piping repair putty or similar material (hereinafter also referred to as putty) is heaped outside the reference circle in a doughnut shape. Next, a tube end of a copper tube with an outer diameter of 20 mm and a wall thickness of 1 mm (the end face is a plane perpendicular to the copper tube longitudinal direction) is placed inside the putty heaped in the doughnut shape and pressed perpendicular to the joined body. Further, putty is additionally applied to seal any gap between the copper tube and the joined body in order to prevent air leakage from any gap between the copper tube and the joined body when air is fed into the copper tube as described below. A regulator and a compressor are then connected to the other end of the copper tube, and airtightness is measured in the same manner as for the case of a tube, described below. When the joined body is too small to draw the reference circle of the above size on the surface of the joined body, one end of the copper tube may be sealed by attaching an auxiliary plate to the joined body or by other means.

### In the Case of a Joined Body of a Stainless Steel Pipe or Tube and a Copper Pipe or Tube (the Stainless Steel and the Copper are Tubular)

One tube end of the joined body is sealed with pipe repair putty or the like and the regulator and the compressor are connected to the other end. Then, under an air environment, the joined body is immersed in water at a depth of 20 cm and air is pumped into the inside of the joined body to set the inside of the joined body to a defined pressure (for example, 0.2 MPa). In the case of the depth of the water varying depending on the position of the fillet welded lap joint due to the fillet welded lap joint not forming a flat surface or for other reasons, it suffices that the entire fillet welded lap joint is immersed in the water and the deepest point is 20 cm below the surface of the water. The airtightness of the joined body is considered to be the defined pressure or more when no air bubbles are generated from the joined body before 10 minutes have elapsed after the inside of the joined body has reached the defined pressure.

In addition, in a stainless steel and copper joined body according to an embodiment of the present disclosure, the joint strength is preferably 60% or more of the strength (tensile strength) of the lower strength of the base metals stainless steel and copper. The joint strength is more preferably 80% or more or the lower strength of the base metals. In particular, by making the Cu/Fe ratio of the fillet welded lap joint 4.0 or more and by making the average diameter Dₘₑₐₙ of the welding points 2t^{0.5} or more and 8t^{0.5} or less, and preferably making the minimum diameter Dₘᵢₙ (mm) and the maximum diameter Dₘₐₓ (mm) of the welding points 2t^{0.5} or more and 8t^{0.5} or less, higher joint strength is obtainable, and specifically, a joint strength is obtainable that is 80% or more of the lower strength of the base metals stainless steel and copper. The reason for this is thought to be that the Cu/Fe ratio of the fillet welded lap joint and the average diameter Dₘₑₐₙ of the welding points being within the ranges described above more effectively suppresses the formation of oxide coating on the stainless steel surface and reduces the amount of the first liquid phase that is mainly composed of the stainless steel component.

Here, joint strength is measured according to JIS Z 2241:2011. However, each tensile test piece is taken from a joined body so that the joined portion (fillet welded lap joint) is a parallel portion of the test piece and the longitudinal direction (tensile direction) of the test piece is perpendicular to the welding direction. The maximum test force obtained from the tensile test is divided by the parallel portion width of the test piece to calculate the maximum test force per unit width (unit length in the longitudinal direction of the fillet welded lap joint). The calculated maximum test force per unit width is then used as the joint strength. Spacers are attached to the grip portions of the tensile test pieces taken from the joined bodies (stainless steel grip portion and copper grip portion) prior to the tensile test so that the tensile axis is parallel to the stainless steel and the copper. Further, the overlapping portion of the stainless steel and the copper is not used as a grip portion.

Further, the strength of the base metals, stainless steel and copper, is measured as follows, for example. Tensile test pieces are taken from a base metal portion of the stainless steel and a base metal portion of the copper in the vicinity the joined portion of the joined body, respectively, so that the longitudinal direction of each test piece coincides with the longitudinal direction (perpendicular-to-welding direction) of the test piece used in the joint strength measurement described above. Then, a tensile test is performed in the same manner as in the measurement of joint strength, and the maximum test force obtained from the tensile test is divided by the parallel portion width of the test piece to calculate the maximum test force per unit width. The maximum test force per unit width of each test piece is then used as the strength of stainless steel or copper, respectively.

The test piece shapes may be determined arbitrarily according to the shape of the joined body, as long as the width of the parallel portion is 1 mm or more and the length of the parallel portion is 5 mm or more.

A stainless steel and copper joined body according to an embodiment of the present disclosure may be either a sheet (including bent sheets (curved sheets) in addition to flat sheets) or tubular, as long as a portion of each material overlaps and includes a fillet welded lap joint. When tubular, the joined body is a joined body of a stainless steel pipe or tube and a copper pipe or tube. For example, in a combination where the outside diameter of a stainless steel pipe or tube is approximately equal to the inside diameter of a copper pipe or tube, in a combination of a stainless steel pipe or tube and a copper pipe or tube with an end expanded to be approximately equal to the outside diameter of the stainless steel pipe or tube, in a combination of a copper pipe or tube and a stainless steel pipe or tube with an end reduced to be approximately equal to the inside diameter of the copper pipe or tube, and the like, the joined body may be a portion of the stainless steel pipe or tube inserted into the copper pipe or tube and joined. Further, a stainless steel and copper joined body according to an embodiment of the present disclosure includes a joined body including a plurality of joined portions, at least one of which is the fillet welded lap joint described above.

$${D}_{max} / {D}_{min} \leq 1.4$$

When Dₘₐₓ/Dₘᵢₙ, the ratio of the maximum diameter Dₘₐₓ (mm) to the minimum diameter Dₘᵢₙ (mm) at multiple welding points (hereinafter also referred to as bead width change ratio), is 1.4 or less, excellent appearance with little bead width change is obtainable. Dₘₐₓ/Dₘᵢₙ is therefore preferably 1.4 or less. Dₘₐₓ/Dₘᵢₙ is more preferably 1.2 or less. A lower limit of Dₘₐₓ/Dₘᵢₙ is not particularly limited. For example, it suffices that Dₘₐₓ/Dₘᵢₙ is 1.0 or more.

Dₘᵢₙ (mm) and Dₘₐₓ are the minimum and maximum values, respectively, of the welding point diameter Dₖ (k=1 to n).

### [2] Stainless Steel and Copper Joining Method

A stainless steel and copper joining method according to an embodiment of the present disclosure is,
a stainless steel and copper joining method, wherein overlapping stainless steel and copper materials to be joined are joined by fillet welding,
the fillet welding is TIG welding,
the TIG welding comprises
positioning an electrode at a copper side of the overlapping portion of the materials to be joined, and performing multiple heat inputs under conditions satisfying (a) to (e) below,
(a) a tilt angle α of the electrode in a perpendicular-to-welding direction: −10° to +60°
here, the thickness direction of the materials to be joined is the reference angle (0°), and a side where a leading end of the electrode is pointed towards the copper side is +ve and a side where the leading end of the electrode is pointed towards the stainless steel side is −ve,
(b) electrode height: more than 0 mm and 3.0 mm or less
(c) each heat input position in the perpendicular-to-welding direction: 0 to +6×t (mm)
here, t is the copper thickness (mm), an end of the copper at the surface of the overlapping portion is the reference position (0), the copper side is +ve and the stainless steel side is −ve,
(d) distance interval in the welding direction between each heat input point: 20% or more to 90% or less of a diameter Dₖ₋₁ (mm) of a welding point formed by the immediately preceding heat input,
(e) time interval between each heat input: 20% or more of the welding time (s) of the immediately preceding heat input,
and further, at each heat input, welding current I (A), welding time d (s), and the copper thickness t (mm) satisfy the relationship of the following Formula (3).

$$500 \leq {I}^{1.5} \times {d}^{0.5} \times {t}^{- 1} \leq 3500 \qquad ( 3 )$$

The stainless steel and copper joining method according to an embodiment of the present disclosure is described below, with reference to the schematic diagram illustrating an example of the spatial arrangement of the materials to be joined in FIG. 3 and the schematic diagram illustrating an example of the spatial arrangement of the electrode in FIG. 4.

In the stainless steel and copper joining method according to an embodiment of the present disclosure, the overlapping stainless steel and copper materials to be joined are joined by a fillet welded lap joint, as illustrated in FIG. 3. For example, in the case of sheet shapes, a copper sheet is preferably disposed overlapping and vertically above a stainless steel sheet. In the case of tubular shapes, overlapping such that a stainless steel pipe or tube is inside and a copper pipe or tube is outside is preferable (for example, a portion of a stainless steel pipe or tube is inserted into a copper pipe or tube). Although not particularly limited, the width of the overlapping portion of the stainless steel and the copper (width in the perpendicular-to-welding direction) is preferably 5 mm to 20 mm. A gap thickness at the overlapping portion between the stainless steel and the copper is not particularly limited. The gap thickness is preferably ½ the copper thickness or less. Preferred thicknesses, shapes, chemical composition, and the like of the stainless steel and the copper are as described under [1].

### Welding method: TIG Welding

In the stainless steel and copper joining method according to an embodiment of the present disclosure, it is necessary to suppress the formation of a firm oxide coating on the surface of the stainless steel caused by heat input for melting the copper. Therefore, the welding method employed in the fillet welded lap joint is TIG welding.

### Electrode Placement: Copper Side of Overlapping Portion of Materials to be Joined

In the stainless steel and copper joining method according to an embodiment of the present disclosure, at each heat input by TIG welding, the heat input point and surroundings, that is, the end portion vicinity of the copper, are melted and solidify on the stainless steel, thereby joining the stainless steel and the copper. For this purpose, the heat input points are on the copper side of the overlapping portion of the materials to be joined, as illustrated in FIG. 4, so that heat input may be preferentially applied to the copper. That is, the electrode is on the copper side of the overlapping portion of the materials to be joined.

Further, in the stainless steel and copper joining method according to an embodiment of the present disclosure, it is important to divide the heat inputs associated with welding into multiple localized and short-duration heat inputs and to satisfy the following conditions (a) to (e). The heat input count is not particularly limited as long as the heat input count is 2 or more. The heat input count is preferably 5 or more. In particular, the heat input count is preferably 3 to 5 per 10 mm in the welding direction.

(a) A tilt angle α of the electrode in a perpendicular-to-welding direction: −10° to +60°

The tilt angle α of the electrode in the perpendicular-to-welding direction (hereinafter also referred to as electrode tilt angle α) is important from the viewpoint of forming a good welded portion. Here, the electrode tilt angle α is the tilt angle from the thickness direction (normal direction to the interface between the materials to be joined) of a straight line connecting the leading end of the electrode and the heat input point projected from the X axis direction on the Y-Z plane (hereinafter also referred to as a first straight line), as illustrated in FIG. 4. The electrode tilt angle α takes the thickness direction as the reference angle (0°), a side where a leading end of the electrode is pointed towards the copper side as +ve and a side where the leading end of the electrode is pointed towards the stainless steel side as −ve, The electrode tilt angle α is defined as an acute angle, that is, −90° or more and 90° or less. As mentioned above, in the stainless steel and copper joining method according to an embodiment of the present disclosure, copper is preferentially melted. Here, when the electrode tilt angle α is less than −10°, stainless steel, not copper, is preferentially melted and the amount of copper melted is insufficient. This leads to the formation of a larger amount of the first liquid phase mainly composed of a stainless steel component, leading to cracking of the welded portion. In particular, to achieve the Cu/Fe ratio of 2.3 or more in the fillet welded lap joint, the electrode tilt angle α needs to be −10° or more after satisfying the relationship in Formula (3) above and the conditions in (c) and (d) below. However, when the electrode tilt angle α exceeds +60°, the heat input area becomes wider and the temperature around the heat input area rises excessively. This causes distortion around the joined portion due to thermal expansion and contraction, resulting in defects in the shape of the joined portion and defects in subsequent joining. The electrode tilt angle α is therefore in the range from −10° to +60°. The electrode tilt angle α is preferably 5° or more. Further, the electrode tilt angle α is preferably 30° or less.

(b) Electrode height: more than 0 mm and 3.0 mm or less

When the electrode height (that is, the distance in the thickness direction between the leading end of the electrode and the materials to be joined) is 0 mm, no arc is generated and welding cannot be performed. When the electrode height exceeds 3.0 mm, the heat input area becomes wider and heat input is dispersed. This results in insufficient copper melting and insufficient joining. The electrode height is therefore more than 0 mm and 3.0 mm or less. When the electrode height is less than 0.5 mm, molten copper may come into contact with the electrode leading end during joining, and may solidify and stick to the electrode. In such a case, the electrode needs to be pulled off the solidified copper, which reduces production efficiency. The electrode height is therefore preferably 0.5 mm or more. Further, when the electrode height exceeds 2.0 mm, the distance between the copper and the electrode leading end becomes difficult to ascertain, making controlling the electrode height difficult. The electrode height is therefore preferably 2.0 mm or less.

(c) Each heat input point position in the perpendicular-to-welding direction: 0 to +6×t (mm)

When heat input is applied to the stainless steel side rather than the copper end portion of the overlapping portion, that is, when the position of each heat input point in the perpendicular-to-welding direction (hereinafter also referred to as heat input point position) is less than 0, the stainless steel melts preferentially and the amount of copper melted is insufficient. This leads to the formation of a larger amount of the first liquid phase mainly composed of a stainless steel component, leading to cracking of the welded portion. On the other hand, when the heat input point position exceeds +6×t, the end portion of the copper does not melt, and visually judging whether the joining condition is good or bad (whether the molten copper is spreads on the stainless steel or not) becomes difficult. As a result, production efficiency is reduced. The heat input point position is therefore in the range of 0 to +6×t. Here, t is the copper thickness (mm). Further, the end of the copper at the surface of the overlapping portion is the reference position (0), the copper side is +ve, and the stainless steel side is −ve, When the width of the overlapping portion of the stainless steel and the copper (width in the perpendicular-to-welding direction) is less than 6×t (mm), the heat input point position is preferably within the width of the overlapping portion of the stainless steel and the copper.

(d) Distance interval (mm) in the welding direction between each heat input point: 20% or more to 90% or less of a diameter Dₖ₋₁ (mm) of a welding point formed by the immediately preceding heat input

As mentioned above, in the stainless steel and copper joining method according to an embodiment of the present disclosure, it is important to divide the heat inputs associated with welding into multiple localized and short-duration heat inputs. In particular, the distance interval in the welding direction between each heat input point (hereinafter also referred to as heat input point interval) is 20% or more and 90% or less of the diameter Dₖ₋₁ of the welding point formed by the immediately preceding heat input (hereinafter also referred to as welding point diameter Dₖ₋₁). This allows the overlap ratio OR of the welding points of the fillet welded lap joint to be 10% or more and 80% or less. Here, when the heat input point interval is less than 20% of the welding point diameter Dₖ₋₁, the heat input count to the same location increases, effectively resulting in excessive heat input to the same location. Accordingly, formation of an oxide coating on the surface of the stainless steel is insufficiently suppressed, and sufficient joint strength becomes unobtainable. Further, formation of the first liquid phase mainly composed of a stainless steel component is increased, leading to cracking of the welded portion. On the other hand, when the heat input point interval exceeds 90% of the welding point diameter Dₖ₋₁, the join between the stainless steel and the copper becomes discontinuous on the back face corresponding to the interface between stainless steel and copper, and sufficient joint strength is unobtainable. Desired airtightness is also unobtainable. The heat input point interval is therefore 20% or more and 90% or less of the welding point diameter Dₖ₋₁. The heat input point interval is preferably 40% or more of the welding point diameter Dₖ₋₁. The heat input point interval is preferably 70% or less of the welding point diameter Dₖ₋₁.

Here, the heat input point interval is the distance between centers of adjacent heat input points. The welding point diameter Dₖ₋₁ (mm) is measured as follows, for example. As illustrated in FIG. 2, the welding points of the fillet welded lap joint are observed with a 10× loupe from a direction perpendicular to the observation plane. The maximum length Lₖ₋₁ of the welding point in the direction perpendicular to the longitudinal direction of the fillet welded lap joint (welding direction) is measured. The Lₖ₋₁ is then used as the welding point diameter Dₖ₋₁. A caliper may be used to measure the maximum length Lₖ₋₁ of the welding point.

(e) Time interval between each heat input: 20% or more of the welding time (s) of the immediately preceding heat input

As mentioned above, in the stainless steel and copper joining method according to an embodiment of the present disclosure, it is important to divide the heat inputs associated with welding into multiple localized and short-duration heat inputs. In particular, the time interval between each heat input (hereinafter also referred to as heat input time interval) is 20% or more of the welding time of the immediately preceding heat input (hereinafter also referred to as heat input time). When the heat input time interval becomes excessively short, specifically, when the heat input time interval is less than 20% of the heat input time, the amount of heat transferred to the vicinity of the heat input area exceeds the amount of heat released from the vicinity of the heat input area, and the temperature around the heat input area increases. Accordingly, formation of an oxide coating on the surface of the stainless steel is insufficiently suppressed, and sufficient joint strength becomes unobtainable. Further, formation of the first liquid phase mainly composed of a stainless steel component is increased, leading to cracking of the welded portion. Further, distortion around the joined portion due to thermal expansion and contraction may occur, resulting in defects in the shape of the joined portion and defects in subsequent joining. The heat input time interval is therefore 20% or more of the heat input time. The heat input time interval is preferably 2000% or more of the heat input time. Further, an upper limit of the heat input time interval is not particularly limited. From the viewpoint of production efficiency, the heat input time interval is preferably 10,000% or less of the heat input time.

Relationship between welding current I (A), welding time d (s) and copper thickness t (mm) at each heat input:

$$500 \leq {I}^{1.5} \times {d}^{0.5} \times {t}^{- 1} \leq 3500 \qquad ( 3 )$$

When I^{1.5}×d^{0.5}×t⁻¹ is less than 500, the average diameter Dₘₑₐₙ of the welding points becomes less than 2t^{0.5} due to insufficient copper melting, resulting in insufficient joining of the stainless steel and the copper. On the other hand, when I^{1.5}×d^{0.5}×t⁻¹ exceeds 3500, the average diameter R of the welding points of the fillet welded lap joint exceeds 10t^{0.5}. That is, more stainless steel is dissolved into the weld metal. This leads to the formation of a larger amount of the first liquid phase mainly composed of a stainless steel component, leading to cracking of the welded portion. Further, the formation of oxide coating on the surface of the stainless steel is not sufficiently suppressed and sufficient joint strength is unobtainable. I^{1.5}×d^{0.5}×t⁻¹ is therefore 500 or more and 3500 or less. I^{1.5}×d^{0.5}×t⁻¹ is preferably 1000 or more. I^{1.5}×d^{0.5}×t⁻¹ is preferably 3000 or less. Further, to obtain higher joint strength, the Cu/Fe ratio of the fillet welded lap joint is 4.0 or more, the average diameter Dₘₑₐₙ of the welding points is 2t^{0.5} or more and 8t^{0.5} or less, and further, in order that the minimum diameter Dₘᵢₙ (mm) and the maximum diameter Dₘₐₓ (mm) of the welding points be 2t^{0.5} or more and 8t^{0.5} or less, I^{1.5}×d^{0.5}×t⁻¹ is more preferably 2500 or less.

When d is less than 0.05 s, the arc may not be stable. When d exceeds 0.40 s, heat is transferred around the heat input area and the surrounding temperature tends to rise. This may cause distortion around the joined portion due to thermal expansion and contraction, which may result in defects in the shape of the joined portion and defects in subsequent joining. Therefore, d is preferably 0.05 s or more. Further, d is preferably 0.40 s or less.

I is selected from t and d above to satisfy Formula (3) above. For example, I may selected from a range of 50 A or more and 500 A or less to satisfy Formula (3) above. From the viewpoint of avoiding distortion in the welded portion, when there are a range of possible values for d and I, setting d as low as possible and I as high as possible is preferable.

When pulse mode, upslope, downslope, and cratering are used for each heat input, the combined time of upslope time, welding time, downslope time, and cratering time is substituted for d, and a time average value of the welding current during that time is substituted for I to calculate the value of I^{1.5}×d^{0.5}×t⁻¹.

Further, the start of each heat input may be done either as a touch start method or as a high-frequency start method. A hot arc may be used to start the heat input. However, the current and time taken at the start of such heat inputs are not included in the welding current I (A) and the welding time d (s) for each heat input.

Conditions other than those described above for TIG welding are not particularly limited and may be in accordance with a conventional method. For example, a typical inert gas may be used for shielding gas and back shielding gas, and 100% Ar is preferred.

Further, when the shielding gas flow rate is less than 1 L/min, an oxide coating is formed on the stainless steel surface in the heat input area, and corrosion resistance of the stainless steel tends to be reduced. On the other hand, when the shielding gas flow rate exceeds 30 L/min, the shielding gas forms turbulence on the join material. When this turbulence entrains air, the inert gas atmosphere around the heat input area is disturbed, causing oxide coating to form on the stainless steel surface in the heat input area, which tends to reduce the corrosion resistance of the stainless steel. The shielding gas flow rate is therefore preferably 1 L/min to 30 L/min. The shielding gas flow rate is more preferably 25 L/min or less.

When the back shielding gas flow rate is less than 1 L/min, an oxide coating is formed on the stainless steel surface at the back side of the heat input location, and the corrosion resistance of the stainless steel tends to be reduced. On the other hand, when the back shielding gas flow rate exceeds 30 L/min, the back shielding gas forms turbulence on the materials to be joined. This turbulence entrains air, which causes oxide coating to form on the stainless steel surface at the back side of the heat input location, which tends to reduce the corrosion resistance of the stainless steel. The back shielding gas flow rate is therefore preferably 1 L/min to 30 L/min. The back shielding gas flow rate is more preferably 25 L/min or less.

When a preflow time is set to 0.05 s or more, heat input is started when a sufficient inert gas atmosphere is formed around the heat input area. This suppresses the formation of oxide coating on the stainless steel and improves the appearance of the weld line. The preflow time is therefore preferably 0.05 s or more. The preflow time is more preferably 0.15 s or more. An upper limit of the preflow time is not particularly limited. For example, 10 s or less is preferred.

When a postflow time is 0.10 s or more, an inert gas atmosphere is formed around the heat input area while the area around the heat input area is still hot after heat input, suppressing the formation of oxide coating on the stainless steel and improving the appearance of the weld line. The postflow time is therefore preferably 0.10 s or more. The postflow time is more preferably 2.0 s or more. An upper limit of the postflow time is not particularly limited. For example, 10 s or less is preferred.

Further, due to the repetition of heat input multiple times, the temperature of the copper material to be joined increases, that is, the melting of copper is easily promoted. Accordingly, the bead width as welding progresses, that is, the maximum length of the welding point in the perpendicular-to-welding direction, may gradually increase. In such a case, for example, use of a chill block or cooling tube to cool the copper and stainless steel to be joined is preferred. This suppresses bead width spreading and produces fillet welded lap joints that have excellent bead width stability. Here, “excellent bead width stability” means that the bead width change ratio expressed as Dₘₐₓ/Dₘᵢₙ is 1.4 or less, in particular 1.2 or less.

In addition to cooling the copper and stainless steel to be joined, at least one of the following (f) to (h), for example, may be performed to preferably obtain a fillet welded lap joint having excellent bead width stability.
(f) For each heat input, the welding current of the heat input is the welding current of the immediately preceding heat input or less.
(g) For each heat input, the welding time of the heat input is the welding time of the immediately preceding heat input or less.
(h) A long heat input time interval is provided between some heat inputs.

(f) For each heat input, the welding current of the heat input is the welding current of the immediately preceding heat input or less.

As the welding progresses, maintaining or decreasing the welding current for each heat input to be the welding current of the immediately preceding heat input or less is preferred. This reduces the heat input amount as the temperature of the copper increases. That is, excessive melting of copper is suppressed. As a result, bead width spreading is suppressed and a fillet welded lap joint with excellent bead width stability is obtainable.

(g) For each heat input, the welding time of the heat input is the welding time of the immediately preceding heat input or less.

As the welding progresses, maintaining or decreasing the welding time for each heat input to be the welding time of the immediately preceding heat input or less is preferred. This reduces the heat input amount as the temperature of the copper increases. That is, excessive melting of copper is suppressed. As a result, bead width spreading is suppressed and a fillet welded lap joint with excellent bead width stability is obtainable.

(h) A long heat input time interval is provided between some heat inputs.

A long heat input time interval is provided between some heat inputs. For example, suppressing excessive heating of the materials to be joined by providing a long heat input time interval for each defined number of heat inputs is preferred. More specifically, an illustrative example may be a repeating pattern such as “three heat inputs at one second intervals, with a five second time interval (long heat input time interval) after the third heat input”. This helps prevent excessively high temperatures in the materials to be joined, and in particular suppresses excessive melting of copper. As a result, bead width spreading is suppressed and a fillet welded lap joint with excellent bead width stability is obtainable.

Here, a long heat input time interval means a longer heat input time interval than the normal heat input time interval. Further, the long heat input time interval is preferably 3.00 s to 6.00 s. The normal heat input time interval may be 0.8 s to 2.0 s, for example. Further, the frequency of the long heat input time intervals is preferably once every 2 to 4 heat input time intervals. The frequency of long heat input time intervals may be constant or not constant.

The length of the welding electrode protruding from the welding nozzle is preferably 3 mm or more to facilitate operation of the welding torch. On the other hand, the length of the welding electrode protruding from the welding nozzle is preferably 10 mm or less to properly form an inert gas atmosphere.

Further, the leading end angle of the welding electrode is preferably 45° or less from the viewpoint of ease of removal in case the electrode leading end sticks to the molten weld pool. On the other hand, the leading end angle of the welding electrode is preferably 15° or more from the viewpoint of reducing the frequency of electrode dressing and increasing production efficiency. The electrode diameter of the welding electrode is preferably 2.4 mm or less from the viewpoint of ease of aiming the heat input position. On the other hand, the electrode diameter of the welding electrode is preferably 1.2 mm or more from the viewpoint of securing the spot welding diameter. The type of welding electrode may be selected arbitrarily. For example, selection may be made from general-purpose electrodes such as thorium-tungsten, cerium-tungsten, lanthanum-tungsten, pure tungsten, and the like.

The stainless steel and copper joining method according to an embodiment of the present disclosure may be implemented, for example, by using an arc spot mode of a TIG welder able to precisely control arc spot time. Further, the stainless steel and copper joining method according to an embodiment of the present disclosure may be implemented by using a low-speed pulse welding mode with an adjusted pulse width in a TIG welder able to precisely adjust pulse width and pulse frequency over a wide range. Further, the stainless steel and copper joining method according to an embodiment of the present disclosure may be implemented in any of the basic welding positions: flat position, vertical position, horizontal position, or overhead position. Therefore, in circumferential welding of pipes or tubes, welding may be performed without rotating the pipe or tube.

### [3] Method of Producing Stainless Steel and Copper Joined Body

The following describes a method of producing a stainless steel and copper joined body according to an embodiment of the present disclosure.

The method of producing a stainless steel and copper joined body according to an embodiment of the present disclosure includes joining stainless steel and copper by the stainless steel and copper joining method according to the embodiment of the present disclosure described above.

The method of producing a stainless steel and copper joined body according to an embodiment of the present disclosure allows production of the stainless steel and copper joined body according to an embodiment of the present disclosure.

### EXAMPLES

### Examples 1

Stainless steel sheets (SUS 443J1, as specified in JIS G 4305:2021) and phosphorous-deoxidized copper sheets (C1220, as specified in JIS H 3100:2018) (hereinafter also referred to simply as “copper sheets”) having the thicknesses listed in Table 1 were cut into 200 mm squares. Next, as the materials to be joined, a copper sheet was placed on a stainless steel sheet so that a 10 mm×200 mm area overlapped. Next, at the overlapping portion of materials to be joined, the stainless steel and the copper, fillet welding by TIG welding was performed under a set of conditions including conditions listed in Table 1 to obtain a joined body of the stainless steel sheet and the copper sheet. The welding was performed using YS-TIG200PACDC, a TIG welder manufactured by Heige Co., Ltd. 100% Ar was used as the shielding gas and the back shielding gas, and the shielding gas flow rate and the back shielding gas flow rate were 25 L/min each. Preflow was 0.2 s and postflow was 2.5 s. Conditions other than those described were in accordance with a conventional method. Further, in Test No. 1-1 to 1-13, welding was performed while the materials to be joined were cooled by a chill block in order to prevent excessive temperature increase of the materials to be joined. On the other hand, in Test No. 1-14 to 1-17, no cooling of the materials to be joined using a chill block or a cooling tube was performed. The numerical values in Table 1, as well as in Tables 2, 3, 4, and 5, are rounded off as appropriate.

In each of Test No. 1-1 to 1-12 and Test No. 1-14 to 1-16, multiple heat inputs were performed under the same conditions. In Test No. 1-13 and Test No. 1-17, TIG welding was performed continuously (not divided into multiple heat inputs) at a welding speed of 60 mm/min with an arc length of 1 mm under a set of conditions including a welding current of 150 A and 90 A, respectively.

Using the joined bodies of the stainless steel sheets and the copper sheets thus obtained, (d) the distance in the welding direction of each heat input point divided by the welding point diameter Dₖ₋₁, (I) the Cu/Fe ratio of the fillet welded lap joint, (II) the average diameter Dₘₑₐₙ of the welding points, and (III) the overlap ratio OR of the welding points were measured as described above. The results are listed in Table 1.

In the measurement of (I), the Cu/Fe ratio of the fillet welded lap joint, a scanning electron microscope (SEM), Miniscope® (Miniscope is a registered trademark in Japan, other countries, or both) TM3030plus, manufactured by Hitachi High-Tech Corporation, and an energy-dispersive X-ray spectrometer (EDS) AZtecOne, manufactured by Oxford Instruments, Ltd., were used.

Further, (IV) airtightness and (V) joint strength were measured as described above and evaluated according to the following criteria. The results are listed in Table 1.
(IV) Airtightness
G (Good, pass): 0.2 MPa or more
P (Poor, fail): less than 0.2 MPa
(V) Joint strength
E (Excellent, pass): joint strength is 80% or more of the lower of the stainless steel and copper strengths
G (Good, pass): joint strength is 60% or more and less than 80% of the lower of the stainless steel and copper strengths
P (Poor, fail): joint strength is less than 60% of the lower of the stainless steel and copper strengths

In the evaluation of (IV) airtightness, RectorSeal from RectorSeal Corporation was used as putty.

TABLE 1

| | | | Heat input conditions | | | | | | |
|---|---|---|---|---|---|---|---|---|---|
| | | | | | | | | (d) | |
| | | | | | | | | | Distance in |
| | Thickness of | | | | | (c) | | | welding direction |
| | materials to | | | (a) | | Heat | | Heat | of each heat input |
| | be joined (mm) | | | Electrode | (b) | input | Heat | input | point ÷ welding |
| | Stainless | | Heat | tilt | Electrode | point | input | point | point diameter |
| Test | steel | Copper | input | angle α | height | position | point | interval | Dₖ₋₁ |
| No. | sheet | sheet t | division | (°) | (mm) | (mm) | position | (mm) | (%) |
| 1-1 | 0.5 | 1.0 | Yes | 0 | 1.0 | +2.0 | +2 × t | 2 | 43~45 |
| 1-2 | 0.3 | 1.0 | Yes | 30 | 1.0 | +4.6 | +4.6 × t | 5 | 67~70 |
| 1-3 | 1.0 | 1.0 | Yes | 15 | 1.0 | +1.0 | +1 × t | 1 | 29~31 |
| 1-4 | 0.1 | 0.5 | Yes | −10 | 0.5 | +2.8 | +5.6 × t | 5 | 86~89 |
| 1-5 | 1.0 | 1.5 | Yes | 55 | 2.0 | +0.2 | +0.1 × t | 1 | 38 |
| 1-6 | 0.5 | 1.0 | Yes | 0 | 1.0 | −0.5 | −0.5 × t | 3 | 56~60 |
| 1-7 | 0.5 | 1.0 | Yes | 0 | 1.0 | +2.0 | +2 × t | 1 | 83 |
| 1-8 | 0.5 | 1.0 | Yes | 0 | 1.0 | +2.0 | +2 × t | 5 | 46~49 |
| 1-9 | 0.5 | 1.0 | Yes | 0 | 1.0 | +2.0 | +2 × t | 5 | 94~98 |
| 1-10 | 0.5 | 1.0 | Yes | 0 | 1.0 | +2.0 | +2 × t | 1 | 16~17 |
| 1-11 | 0.5 | 1.0 | Yes | −20 | 1.0 | +2.0 | +2 × t | 2 | 41~44 |
| 1-12 | 0.5 | 1.0 | Yes | 0 | 1.0 | +2.0 | +2 × t | 2 | 40~43 |
| 1-13 | 0.5 | 1.0 | No | 0 | 1.0 | +2.0 | +2 × t | — | — |
| 1-14 | 0.5 | 1.0 | Yes | 0 | 1.0 | +2.0 | +2 × t | 2 | 29~45 |
| 1-15 | 0.3 | 1.0 | Yes | 30 | 1.0 | +4.6 | +4.6 × t | 5 | 56~70 |
| 1-16 | 1.0 | 1.0 | Yes | 15 | 1.0 | +1.0 | +1 × t | 1 | 20~31 |
| 1-17 | 0.5 | 1.0 | No | 0 | 1.0 | +2.0 | +2 × t | — | — |

| | Heat input conditions | | | | | | |
|---|---|---|---|---|---|---|---|
| | (e) | | | | | | |
| | | Heat | | | | | |
| | | input time | | | | | |
| | Heat | interval ÷ | | | | | |
| | input | welding | | | | | |
| | time | time | Welding | Welding | I^{1.5} × | Heat | |
| Test | interval | d × 100 | current I | time d | d^{0.5} × | input | |
| No. | (s) | (%) | (A) | (s) | t⁻¹ | count | Remarks |
| 1-1 | 5.50 | 2200 | 190 | 0.25 | 1309 | 87 | Example |
| 1-2 | 1.50 | 214 | 200 | 0.70 | 2366 | 35 | Example |
| 1-3 | 1.80 | 900 | 150 | 0.20 | 822 | 178 | Example |
| 1-4 | 0.80 | 20 | 80 | 4.00 | 2862 | 35 | Example |
| 1-5 | 9.00 | 6000 | 170 | 0.15 | 572 | 175 | Example |
| 1-6 | 0.80 | 320 | 190 | 0.25 | 1309 | 62 | Comparative |
| | | | | | | | Example |
| 1-7 | 0.80 | 2667 | 150 | 0.03 | 318 | 182 | Comparative |
| | | | | | | | Example |
| 1-8 | 0.80 | 40 | 200 | 2.00 | 4000 | 39 | Comparative |
| | | | | | | | Example |
| 1-9 | 0.80 | 229 | 200 | 0.35 | 1673 | 34 | Comparative |
| | | | | | | | Example |
| 1-10 | 0.80 | 160 | 200 | 0.50 | 2000 | 173 | Comparative |
| | | | | | | | Example |
| 1-11 | 5.50 | 2200 | 190 | 0.25 | 1309 | 88 | Comparative |
| | | | | | | | Example |
| 1-12 | 0.70 | 16 | 80 | 3.60 | 1358 | 89 | Comparative |
| | | | | | | | Example |
| 1-13 | — | — | 150 | — | — | 1 | Comparative |
| | | | | | | | Example |
| 1-14 | 5.50 | 2200 | 190 | 0.25 | 1309 | 87 | Example |
| 1-15 | 1.50 | 214 | 200 | 0.70 | 2366 | 35 | Example |
| 1-16 | 1.80 | 900 | 150 | 0.20 | 822 | 178 | Example |
| 1-17 | — | — | 90 | — | — | 1 | Comparative |
| | | | | | | | Example |

| | Joint | | | | | | | |
|---|---|---|---|---|---|---|---|---|
| | | (II) | | | (III) | | | |
| | (I) | Average | | | Overlap | | | |
| | Cu/Fe | diameter | | | ratio | | | |
| | ratio of | Dₘₑₐₙ Of | | | OR of | Evaluation results | | |
| | fillet | welding | | | welding | | (V) | |
| Test | welded | points | | | points | (IV) | Joint | |
| No. | lap joint | (mm) | 2t^{0.5} | 10t^{0.5} | (%) | Airtightness | strength | Remarks |
| 1-1 | 19.0 | 4.5 | 2.0 | 10.0 | 56 | G | E | Example |
| 1-2 | 5.7 | 7.3 | 2.0 | 10.0 | 32 | G | E | Example |
| 1-3 | 49.0 | 3.3 | 2.0 | 10.0 | 70 | G | E | Example |
| 1-4 | 3.5 | 5.7 | 1.4 | 7.1 | 12 | G | G | Example |
| 1-5 | 24.0 | 2.6 | 2.4 | 12.2 | 62 | G | E | Example |
| 1-6 | 0.8 | 5.2 | 2.0 | 10.0 | 42 | P | P | Comparative Example |
| 1-7 | 99.0 | 1.2 | 2.0 | 10.0 | 17 | P | P | Comparative Example |
| 1-8 | 1.4 | 10.6 | 2.0 | 10.0 | 53 | P | P | Comparative Example |
| 1-9 | 11.5 | 5.2 | 2.0 | 10.0 | 4 | P | P | Comparative Example |
| 1-10 | 1.6 | 6.2 | 2.0 | 10.0 | 84 | P | P | Comparative Example |
| 1-11 | 1.9 | 4.7 | 2.0 | 10.0 | 57 | P | P | Comparative Example |
| 1-12 | 1.2 | 4.8 | 2.0 | 10.0 | 58 | P | P | Comparative Example |
| 1-13 | 1.6 | — | — | — | — | P | P | Comparative Example |
| 1-14 | 10.4 | 6.0 | 2.0 | 10.0 | 67 | G | E | Example |
| 1-15 | 3.6 | 8.2 | 2.0 | 10.0 | 39 | G | G | Example |
| 1-16 | 25.2 | 4.6 | 2.0 | 10.0 | 78 | G | E | Example |
| 1-17 | 1.3 | — | — | — | — | P | P | Comparative Example |

As illustrated in Table 1, all of the Examples achieved the desired bodies with sufficient joint strength were obtained without cracking or join discontinuities in the welded portion. In particular, excellent joint strength was obtained in Test No. 1-1, 1-2, 1-3, 1-5, 1-14, and 1-16. Here, as mentioned above, for all of the above Examples, multiple heat inputs were all performed under the same conditions. Even in a case where multiple heat inputs are each under different conditions, specifically, even in a case where the heat input conditions are varied for each heat input based on the test conditions of the

Examples, the desired Cu/Fe ratio of the fillet welded lap joint, the desired average diameter Dₘₑₐₙ of the welding points, and the overlap ratio OR of the welding points are obtainable when the conditions (a) to (e) and the relationship of Formula (3) are satisfied, as described above. Further, desired airtightness and joint strength were confirmed as obtainable.

On the other hand, both airtightness and joint strength were insufficient in the Comparative Examples.

In other words, in the Comparative Example of Test No. 1-6, the heat input point positions were not within the appropriate range, and therefore the Cu/Fe ratio of the fillet welded lap joint was not within the appropriate range, resulting in cracking in the welded portion, and the desired airtightness was not obtained. Further, joint strength was insufficient.

In the Comparative Example of Test No. 1-7, the lower limit of Formula (3) was not met, and therefore the average diameter Dₘₑₐₙ of the welding points was less than the lower limit of Formula (1), resulting in discontinuity in the joining of the stainless steel and the copper, and the desired airtightness was not obtained. Further, joint strength was insufficient.

In the Comparative Example of Test No. 1-8, the upper limit of Formula (3) was exceeded, and therefore the heat input amount was too large, the average diameter Dₘₑₐₙ of the welding points exceeded the upper limit of Formula (1), and the desired joint strength was not obtained. Further, the Cu/Fe ratio of the fillet welded lap joint was not within the appropriate range, causing cracking in the welded portion, and the desired airtightness was not obtained.

In the Comparative Example of Test No. 1-9, the heat input point distance interval was too large, and therefore the overlap ratio OR of the welding points was not within the appropriate range, discontinuity occurred in the joining of the stainless steel and the copper, and the desired airtightness was not obtained. Further, joint strength was insufficient.

In the Comparative Example of Test No. 1-10, the heat input point distance interval was too small, and therefore the heat input amount was too large, the overlap ratio OR of the welding points exceeded the appropriate range, and the desired joint strength was not obtained. Further, the Cu/Fe ratio of the fillet welded lap joint was not within the appropriate range, causing cracking in the welded portion, and the desired airtightness was not obtained.

In the Comparative Example of Test No. 1-11, the electrode tilt angle was not within the appropriate range, and therefore the Cu/Fe ratio of the fillet welded lap joint was also not within the appropriate range, resulting in cracking and the desired airtightness not being obtained. Further, joint strength was insufficient.

In the Comparative Examples of Test No. 1-12, the heat input time interval was not within the appropriate range, and therefore the Cu/Fe ratio of the fillet welded lap joint was not within the appropriate range, resulting in cracking, and the desired airtightness was not obtained. Further, joint strength was insufficient.

In the Comparative Examples of Test No. 1-13 and 1-17, TIG welding with a bead length of 175 mm was performed continuously (not divided into multiple heat inputs), and therefore the heat input amount was large and the desired joint strength was not obtained. Further, the Cu/Fe ratio of the fillet welded lap joint was not within the appropriate range, causing cracking in the welded portion, and the desired airtightness was not obtained.

### Examples 2

Stainless steel tubes (welded tubes made from SUS304, SUS316L, SUS443J1, SUS445J1, SUS430J1L, and SUS444 stainless steel sheets as specified in JIS G 4305:2021) having the outer diameters and thicknesses (wall thicknesses) listed in Table 2; and copper tubes (phosphorous-deoxidized copper tubes (C1220T) and brass tube (C2700T) specified in JIS H 3300:2018) having the outer diameters and thicknesses (wall thicknesses) listed in Table 2 were cut into 200 mm lengths, and the stainless steel tubes were inserted inside the copper tubes so that a 10 mm length overlapped as the materials to be joined. Next, at the overlapping portion between the stainless steel and the copper of the materials to be joined, a fillet welded lap joint by TIG welding was performed under a set of conditions including the conditions listed in Table 2 to obtain a joined body of the stainless steel tube and the copper tube. The welding points were equally spaced around the entire circumference of the overlapping portion (once round) so that the fillet welded lap joint was formed around the entire circumference. 100% Ar was used as the shielding gas and the back shielding gas, and the shielding gas flow rate and the back shielding gas flow rate were 25 L/min each. Preflow was 0.5 s and postflow was 3.0 s. Conditions other than those described were in accordance with a conventional method. Further, in Test No. 2-1 to 2-9, the welding was performed while the materials to be joined were cooled by wrapping a cooling tube connected to a chiller in order to prevent excessive temperature increase of the materials to be joined. On the other hand, in Test No. 2-10, no cooling of the materials to be joined using a chill block or cooling tube was performed.

Using the joined bodies of the stainless steel tubes and the copper tubes thus obtained, (d) the distance in the welding direction of each heat input point divided by the welding point diameter Dₖ₋₁, (I) the Cu/Fe ratio of the fillet welded lap joint, (II) the average diameter Dₘₑₐₙ of the welding points, and (III) the overlap ratio OR of the welding points were measured as described above. The results are listed in Table 2.

Further, (IV) airtightness and (V) joint strength were measured as described above and evaluated according to the same criteria as in Examples 1. The results are listed in Table 2.

The conditions other than those described above and in Table 2 were the same as in Examples 1.

TABLE 2

| | | | | | | | Heat input conditions | | | | |
|---|---|---|---|---|---|---|---|---|---|---|---|
| | | | Thickness of | | | | | | | (c) | |
| | Outer diameter | | materials to | | Type of materials | | | | | Heat | |
| | of materials to | | be joined (mm) | | to be joined | | | (a) | (b) | input | Heat |
| | be joined (mm) | | | Copper | Stainless | | Heat | Electrode | Electrode | point | input |
| Test | Stainless | Copper | Stainless | tube | steel | Copper | input | tilt angle α | height | position | point |
| No. | steel tube | tube | steel tube | t | tube | tube | division | (°) | (mm) | (mm) | position |
| 2-1 | 10 | 12 | 0.5 | 1.0 | SUS443J1 | C1220T | Yes | 10 | 1.0 | +2.0 | +2 × t |
| 2-2 | 10 | 12 | 0.5 | 1.0 | SUS316L | C1220T | Yes | 10 | 1.0 | +2.0 | +1 × t |
| 2-3 | 5 | 6 | 0.3 | 0.5 | SUS445J1 | C1220T | Yes | 10 | 1.5 | +1.0 | +2 × t |
| 2-4 | 5 | 6 | 0.3 | 0.5 | SUS430J1L | C1220T | Yes | 10 | 1.0 | 0.0 | 0 |
| 2-5 | 12 | 15 | 1.0 | 1.5 | SUS304 | C1220T | Yes | 10 | 0.5 | +2.0 | +1.3 × t |
| 2-6 | 12 | 15 | 1.0 | 1.5 | SUS444 | C2700T | Yes | 10 | 1.0 | +3.0 | +2 × t |
| 2-7 | 10 | 12 | 0.5 | 1.0 | SUS304 | C1220T | Yes | 10 | 1.0 | +2.0 | +2 × t |
| 2-8 | 10 | 12 | 0.5 | 1.0 | SUS304 | C1220T | Yes | 10 | 1.0 | +2.0 | +2 × t |
| 2-9 | 10 | 12 | 0.5 | 1.0 | SUS443J1 | C1220T | Yes | −20 | 1.0 | +2.0 | +2 × t |
| 2-10 | 10 | 12 | 0.5 | 1.0 | SUS443J1 | C1220T | Yes | 10 | 1.0 | +2.0 | +2 × t |

| | Heat input conditions | | | | | | | | |
|---|---|---|---|---|---|---|---|---|---|
| | (d) | | | | | | | | |
| | | Distance | (e) | | | | | | |
| | | in welding | | Heat | | | | | |
| | | direction | | input time | | | | | |
| | Heat | of each heat | Heat | interval ÷ | | | | | |
| | input | input point ÷ | input | welding | | | | | |
| | point | welding point | direction | time | Welding | Welding | I^{1.5} × | Heat | |
| Test | interval | diameter Dₖ₋₁ | interval | d × 100 | current I | time d | d^{0.5} × | input | |
| No. | (mm) | (%) | (s) | (%) | (A) | (s) | t⁻¹ | count | Remarks |
| 2-1 | 2 | 42~46 | 2.00 | 800 | 200 | 0.25 | 1414 | 18 | Example |
| 2-2 | 3 | 53~57 | 0.50 | 143 | 180 | 0.35 | 1429 | 14 | Example |
| 2-3 | 2 | 51~56 | 0.80 | 320 | 150 | 0.25 | 1837 | 8 | Example |
| 2-4 | 2 | 41~43 | 2.93 | 4186 | 200 | 0.07 | 1497 | 12 | Example |
| 2-5 | 3 | 54~60 | 0.50 | 33 | 150 | 1.50 | 1500 | 14 | Example |
| 2-6 | 2 | 44~47 | 2.50 | 500 | 190 | 0.50 | 1235 | 20 | Example |
| 2-7 | 1 | 47~53 | 0.95 | 1900 | 150 | 0.05 | 411 | 40 | Comparative |
| | | | | | | | | | Example |
| 2-8 | 5 | 43~47 | 3.20 | 178 | 200 | 1.80 | 3795 | 8 | Comparative |
| | | | | | | | | | Example |
| 2-9 | 2 | 40~44 | 2.00 | 800 | 200 | 0.25 | 1414 | 18 | Comparative |
| | | | | | | | | | Example |
| 2-10 | 2 | 31~46 | 2.00 | 800 | 200 | 0.25 | 1414 | 18 | Example |

| | Joint | | | | | | | |
|---|---|---|---|---|---|---|---|---|
| | | (II) | | | | | | |
| | (I) | Average | | | (III) | | | |
| | Cu/Fe | diameter | | | Overlap | | | |
| | ratio of | Dₘₑₐₙ of | | | ratio OR | Evaluation results | | |
| | fillet | welding | | | of welding | | (V) | |
| Test | welded | points | | | points | (IV) | Joint | |
| No. | lap joint | (mm) | 2t^{0.5} | 10t^{0.5} | (%) | Airtightness | strength | Remarks |
| 2-1 | 15.7 | 4.8 | 2.0 | 10.0 | 56 | G | E | Example |
| 2-2 | 15.7 | 4.9 | 2.0 | 10.0 | 45 | G | E | Example |
| 2-3 | 10.1 | 4.5 | 1.4 | 7.1 | 48 | G | E | Example |
| 2-4 | 13.3 | 3.8 | 1.4 | 7.1 | 59 | G | E | Example |
| 2-5 | 11.5 | 6.0 | 2.4 | 12.2 | 44 | G | E | Example |
| 2-6 | 8.1 | 5.3 | 2.4 | 12.2 | 56 | G | E | Example |
| 2-7 | 99.0 | 1.8 | 2.0 | 10.0 | 48 | P | P | Comparative Example |
| 2-8 | 1.6 | 10.5 | 2.0 | 10.0 | 55 | P | P | Comparative Example |
| 2-9 | 1.8 | 5.0 | 2.0 | 10.0 | 58 | P | P | Comparative Example |
| 2-10 | 10.4 | 6.3 | 2.0 | 10.0 | 67 | G | E | Example |

As indicated in Table 2, all of the Examples achieved the desired bodies with sufficient joint strength were obtained without cracking or join discontinuities in the welded portion. Further, in particular, excellent joint strength was obtained in all Examples. Here, in all of the above Examples, multiple heat inputs were all performed under the same conditions. Even in a case where multiple heat inputs are each under different conditions, specifically, even in a case where the heat input conditions are varied for each heat input based on the test conditions of the Examples, the desired Cu/Fe ratio of the fillet welded lap joint, the average diameter Dₘₑₐₙ of the welding points, and the overlap ratio OR of the welding points are obtainable when the conditions (a) to (e) and the relationship of Formula (3) are satisfied, as described above. Further, desired airtightness and joint strength were confirmed as obtainable.

On the other hand, both airtightness and joint strength were insufficient in the Comparative Examples.

That is, in the Comparative Example of Test No. 2-7, the lower limit of Formula (3) was not met, and therefore the average diameter Dₘₑₐₙ of the welding points was less than the lower limit of Formula (1), resulting in discontinuity in the joining of the stainless steel and the copper, and the desired airtightness was not obtained. Further, joint strength was insufficient.

In the Comparative Example of Test No. 2-8, the upper limit of Formula (3) was exceeded, and therefore the heat input amount was too large, the average diameter Dₘₑₐₙ of the welding points exceeded the upper limit of Formula (1), and the desired joint strength was not obtained. Further, the Cu/Fe ratio of the fillet welded lap joint was not within the appropriate range, causing cracking in the welded portion, and the desired airtightness was not obtained.

In the Comparative Example of Test No. 2-9, the electrode tilt angle was not within the appropriate range, and therefore the Cu/Fe ratio of the fillet welded lap joint was also not within the appropriate range, resulting in cracking and the desired airtightness not being obtained. Further, joint strength was insufficient.

### Examples 3

Stainless steel sheets (SUS443J1 specified in JIS G 4305:2021) having a length of 40 mm, a width of 50 mm, and a thickness of 1.5 mm, and phosphorous-deoxidized copper sheets (C1220 specified in JIS H 3100:2018) having a length of 40 mm, a width of 40 mm, and a thickness of 0.5 mm (hereinafter also referred to simply as “copper sheets”) were cut out. Next, as the materials to be joined, a copper sheet was placed on a stainless steel sheet so that a 20 mm wide area overlapped. Next, fillet welding by TIG welding was performed on the overlapping portion of materials to be joined, the stainless steel and the copper. Welding conditions were as listed in Tables 3 and 4. Further conditions were (a) electrode tilt angle: 0°, (b) electrode height: 1.0 mm, and (c) heat input point position: +1.0 mm. The heat input count was 15 for each case. This formed a fillet welded lap joint, resulting in a joined body of the stainless steel sheet and the copper sheet. The welder used was YS-TIG200PACDC, a TIG welder manufactured by Heige Co., Ltd. 100% Ar was used as the shielding gas and the back shielding gas at a gas flow rate of 25 L/min, respectively. Preflow was 0.3 s and postflow was 2.0 s. Conditions other than those described were in accordance with a conventional method. In Test No. 3-3 and Test No. 3-4, the materials to be joined were cooled using a chill block. On the other hand, in Test No. 3-1 and Test No. 3-2, no cooling of the materials to be joined using a chill block or cooling tube was performed.

Here, condition A in Table 4 is a set of conditions where none of (f) to (h) were satisfied, as described above, and the welding current, the welding time, and the heat input time interval for each heat input were constant. Further, condition B in Table 4 is a set of conditions where (f) and (h) were satisfied, as described above.

Using the joined bodies of the stainless steel sheets and the copper sheets, and the joined bodies of the stainless steel tubes and the copper tubes thus obtained, (d) the distance in the welding direction of each heat input point divided by the welding point diameter Dₖ₋₁, (I) the Cu/Fe ratio of the fillet welded lap joint, (II) the average diameter Dₘₑₐₙ, the minimum diameter Dₘᵢₙ, and the maximum diameter Dₘₐₓ of the welding points, and (III) the overlap ratio OR of the welding points were measured. The results are listed in Table 3.

Further, (IV) airtightness and (V) joint strength were measured as described above and evaluated according to the same criteria as in Examples 1. The results are listed in Table 3.

Further, the bead width change ratio (Dₘᵢₙ/Dₘₐₓ) was calculated from the minimum diameter Dₘᵢₙ and the maximum diameter Dₘₐₓ of the welding points. The results are listed in Table 3.

TABLE 3

| | Heat input conditions | | | | | | |
|---|---|---|---|---|---|---|---|
| | | (d) | | Joint | | | |
| | | | Distance in | | (II) | | |
| | | | welding direction | (I) | Average | Maximum | Minimum |
| | | Heat | of each heat input | Cu/Fe | diameter | diameter | diameter |
| | | input | point ÷ welding | ratio of | Dₘₑₐₙ of | Dₘₐₓ of | Dₘᵢₙ of |
| | Heat input | point | point diameter | filet | welding | welding | welding |
| Test | conditions | interval | Dₖ₋₁ | welded | points | points | points |
| No. | (Table 5) | (mm) | (%) | lap joint | (mm) | (mm) | (mm) |
| 3-1 | Condition A | 2.4 | 41~53 | 5.2 | 5.4 | 5.9 | 4.5 |
| 3-2 | Condition B | 2.4 | 49~53 | 8.1 | 4.7 | 4.9 | 4.5 |
| 3-3 | Condition A | 2.4 | 48~53 | 8.3 | 4.8 | 5.0 | 4.5 |
| 3-4 | Condition B | 2.4 | 52~52 | 10.6 | 4.6 | 4.6 | 4.5 |

| | Joint | | | | | | |
|---|---|---|---|---|---|---|---|
| | | | (III) | Evaluation results | | | |
| | | | Overlap | | | (VI) | |
| | | | ratio OR | | | Bead | |
| | | | of welding | | (V) | width | |
| Test | | | points | (IV) | Joint | change | |
| No. | 2t^{0.5} | 10t^{0.5} | (%) | Airtightness | strength | ratio | Remarks |
| 3-1 | 1.4 | 7.1 | 56 | G | E | 1.3 | Example |
| 3-2 | 1.4 | 7.1 | 49 | G | E | 1.1 | Example |
| 3-3 | 1.4 | 7.1 | 50 | G | E | 1.1 | Example |
| 3-4 | 1.4 | 7.1 | 48 | G | E | 1.0 | Example |

TABLE 4

| | | | | | (e) | |
|---|---|---|---|---|---|---|
| | | | | | | Heat |
| | | | | | Heat | input time |
| | | | | | input | interval ÷ |
| | | Welding | Welding | I^{1.5} × | time | welding time |
| | | current I | time d | d^{0.5} × | interval | d × 100 |
| Conditions | | (A) | (s) | t⁻¹ | (s) | (%) |
| Condition A | 1st heat input conditions | 180 | 0.15 | 1871 | | |
| (conditions | 2nd heat input conditions | 180 | 0.15 | 1871 | 0.85 | 567 |
| constant) | 3rd heat input conditions | 180 | 0.15 | 1871 | 0.85 | 567 |
| | 4th heat input conditions | 180 | 0.15 | 1871 | 0.85 | 567 |
| | 5th heat input conditions | 180 | 0.15 | 1871 | 0.85 | 567 |
| | 6th heat input conditions | 180 | 0.15 | 1871 | 0.85 | 567 |
| | 7th heat input conditions | 180 | 0.15 | 1871 | 0.85 | 567 |
| | 8th heat input conditions | 180 | 0.15 | 1871 | 0.85 | 567 |
| | 9th heat input conditions | 180 | 0.15 | 1871 | 0.85 | 567 |
| | 10th heat input conditions | 180 | 0.15 | 1871 | 0.85 | 567 |
| | 11th heat input conditions | 180 | 0.15 | 1871 | 0.85 | 567 |
| | 12th heat input conditions | 180 | 0.15 | 1871 | 0.85 | 567 |
| | 13th heat input conditions | 180 | 0.15 | 1871 | 0.85 | 567 |
| | 14th heat input conditions | 180 | 0.15 | 1871 | 0.85 | 567 |
| | 15th heat input conditions | 180 | 0.15 | 1871 | 0.85 | 567 |
| Condition B | 1st heat input conditions | 180 | 0.15 | 1871 | | |
| (f) + (h) | 2nd heat input conditions | 180 | 0.15 | 1871 | 0.85 | 567 |
| | 3rd heat input conditions | 170 | 0.15 | 1717 | 0.85 | 567 |
| | 4th heat input conditions | 170 | 0.15 | 1717 | 5.85 | 3900 |
| | 5th heat input conditions | 170 | 0.15 | 1717 | 0.85 | 567 |
| | 6th heat input conditions | 160 | 0.15 | 1568 | 0.85 | 567 |
| | 7th heat input conditions | 160 | 0.15 | 1568 | 5.85 | 3900 |
| | 8th heat input conditions | 160 | 0.15 | 1568 | 0.85 | 567 |
| | 9th heat input conditions | 160 | 0.15 | 1568 | 0.85 | 567 |
| | 10th heat input conditions | 150 | 0.15 | 1423 | 5.85 | 3900 |
| | 11th heat input conditions | 150 | 0.15 | 1423 | 0.85 | 567 |
| | 12th heat input conditions | 150 | 0.15 | 1423 | 0.85 | 567 |
| | 13th heat input conditions | 150 | 0.15 | 1423 | 5.85 | 3900 |
| | 14th heat input conditions | 150 | 0.15 | 1423 | 0.85 | 567 |
| | 15th heat input conditions | 150 | 0.15 | 1423 | 0.85 | 567 |
| Condition C | 1st heat input conditions | 200 | 0.41 | 1811 | | |
| (conditions | 2nd heat input conditions | 200 | 0.41 | 1811 | 0.70 | 171 |
| constant) | 3rd heat input conditions | 200 | 0.41 | 1811 | 0.70 | 171 |
| | 4th heat input conditions | 200 | 0.41 | 1811 | 0.70 | 171 |
| | 5th heat input conditions | 200 | 0.41 | 1811 | 0.70 | 171 |
| | 6th heat input conditions | 200 | 0.41 | 1811 | 0.70 | 171 |
| | 7th heat input conditions | 200 | 0.41 | 1811 | 0.70 | 171 |
| | 8th heat input conditions | 200 | 0.41 | 1811 | 0.70 | 171 |
| | 9th heat input conditions | 200 | 0.41 | 1811 | 0.70 | 171 |
| | 10th heat input conditions | 200 | 0.41 | 1811 | 0.70 | 171 |
| | 11th heat input conditions | 200 | 0.41 | 1811 | 0.70 | 171 |
| | 12th heat input conditions | 200 | 0.41 | 1811 | 0.70 | 171 |
| | 13th heat input conditions | 200 | 0.41 | 1811 | 0.70 | 171 |
| Condition D | 1st heat input conditions | 200 | 0.41 | 1811 | | |
| (g) | 2nd heat input conditions | 200 | 0.30 | 1549 | 0.70 | 171 |
| | 3rd heat input conditions | 200 | 0.30 | 1549 | 0.70 | 233 |
| | 4th heat input conditions | 200 | 0.30 | 1549 | 0.70 | 233 |
| | 5th heat input conditions | 200 | 0.21 | 1296 | 0.70 | 233 |
| | 6th heat input conditions | 200 | 0.21 | 1296 | 0.70 | 333 |
| | 7th heat input conditions | 200 | 0.21 | 1296 | 0.70 | 333 |
| | 8th heat input conditions | 200 | 0.21 | 1296 | 0.70 | 333 |
| | 9th heat input conditions | 200 | 0.21 | 1296 | 0.70 | 333 |
| | 10th heat input conditions | 200 | 0.21 | 1296 | 0.70 | 333 |
| | 11th heat input conditions | 200 | 0.21 | 1296 | 0.70 | 333 |
| | 12th heat input conditions | 200 | 0.21 | 1296 | 0.70 | 333 |
| | 13th heat input conditions | 200 | 0.21 | 1296 | 0.70 | 333 |
| Condition E | 1st heat input conditions | 200 | 0.41 | 1811 | | |
| (f) | 2nd heat input conditions | 190 | 0.41 | 1677 | 0.70 | 171 |
| | 3rd heat input conditions | 180 | 0.41 | 1546 | 0.70 | 171 |
| | 4th heat input conditions | 180 | 0.41 | 1546 | 0.70 | 171 |
| | 5th heat input conditions | 170 | 0.41 | 1419 | 0.70 | 171 |
| | 6th heat input conditions | 170 | 0.41 | 1419 | 0.70 | 171 |
| | 7th heat input conditions | 160 | 0.41 | 1296 | 0.70 | 171 |
| | 8th heat input conditions | 160 | 0.41 | 1296 | 0.70 | 171 |
| | 9th heat input conditions | 150 | 0.41 | 1176 | 0.70 | 171 |
| | 10th heat input conditions | 150 | 0.41 | 1176 | 0.70 | 171 |
| | 11th heat input conditions | 150 | 0.41 | 1176 | 0.70 | 171 |
| | 12th heat input conditions | 150 | 0.41 | 1176 | 0.70 | 171 |
| | 13th heat input conditions | 150 | 0.41 | 1176 | 0.70 | 171 |
| Condition F | 1st heat input conditions | 200 | 0.41 | 1811 | | |
| (h) | 2nd heat input conditions | 200 | 0.41 | 1811 | 0.70 | 171 |
| | 3rd heat input conditions | 200 | 0.41 | 1811 | 0.70 | 171 |
| | 4th heat input conditions | 200 | 0.41 | 1811 | 0.70 | 171 |
| | 5th heat input conditions | 200 | 0.41 | 1811 | 2.70 | 659 |
| | 6th heat input conditions | 200 | 0.41 | 1811 | 0.70 | 171 |
| | 7th heat input conditions | 200 | 0.41 | 1811 | 0.70 | 171 |
| | 8th heat input conditions | 200 | 0.41 | 1811 | 0.70 | 171 |
| | 9th heat input conditions | 200 | 0.41 | 1811 | 2.70 | 659 |
| | 10th heat input conditions | 200 | 0.41 | 1811 | 0.70 | 171 |
| | 11th heat input conditions | 200 | 0.41 | 1811 | 0.70 | 171 |
| | 12th heat input conditions | 200 | 0.41 | 1811 | 0.70 | 171 |
| | 13th heat input conditions | 200 | 0.41 | 1811 | 2.70 | 659 |
| Condition G | 1st heat input conditions | 200 | 0.41 | 1811 | | |
| (f) + (g) | 2nd heat input conditions | 190 | 0.41 | 1677 | 0.70 | 171 |
| | 3rd heat input conditions | 180 | 0.41 | 1546 | 0.70 | 171 |
| | 4th heat input conditions | 180 | 0.41 | 1546 | 0.70 | 171 |
| | 5th heat input conditions | 180 | 0.30 | 1323 | 0.70 | 171 |
| | 6th heat input conditions | 180 | 0.30 | 1323 | 0.70 | 233 |
| | 7th heat input conditions | 180 | 0.30 | 1323 | 0.70 | 233 |
| | 8th heat input conditions | 180 | 0.30 | 1323 | 0.70 | 233 |
| | 9th heat input conditions | 180 | 0.21 | 1107 | 0.70 | 233 |
| | 10th heat input conditions | 180 | 0.21 | 1107 | 0.70 | 333 |
| | 11th heat input conditions | 180 | 0.21 | 1107 | 0.70 | 333 |
| | 12th heat input conditions | 180 | 0.21 | 1107 | 0.70 | 333 |
| | 13th heat input conditions | 180 | 0.21 | 1107 | 0.70 | 333 |
| Condition H | 1st heat input conditions | 200 | 0.41 | 1811 | | |
| (g) + (h) | 2nd heat input conditions | 200 | 0.41 | 1811 | 0.70 | 171 |
| | 3rd heat input conditions | 200 | 0.30 | 1549 | 0.70 | 171 |
| | 4th heat input conditions | 200 | 0.30 | 1549 | 0.70 | 233 |
| | 5th heat input conditions | 200 | 0.30 | 1549 | 8.70 | 2900 |
| | 6th heat input conditions | 200 | 0.30 | 1549 | 0.70 | 233 |
| | 7th heat input conditions | 200 | 0.21 | 1296 | 0.70 | 233 |
| | 8th heat input conditions | 200 | 0.21 | 1296 | 0.70 | 333 |
| | 9th heat input conditions | 200 | 0.2 | 1296 | 8.70 | 4143 |
| | 10th heat input conditions | 200 | 0.21 | 1296 | 0.70 | 333 |
| | 11th heat input conditions | 200 | 0.21 | 1296 | 0.70 | 333 |
| | 12th heat input conditions | 200 | 0.21 | 1296 | 0.70 | 333 |
| | 13th heat input conditions | 200 | 0.21 | 1296 | 8.70 | 4143 |
| Condition I | 1st heat input conditions | 200 | 0.41 | 1811 | | |
| (f) + (g) + (h) | 2nd heat input conditions | 200 | 0.41 | 1811 | 0.70 | 171 |
| | 3rd heat input conditions | 200 | 0.41 | 1811 | 0.70 | 171 |
| | 4th heat input conditions | 180 | 0.30 | 1323 | 3.70 | 902 |
| | 5th heat input conditions | 180 | 0.30 | 1323 | 0.70 | 233 |
| | 6th heat input conditions | 180 | 0.30 | 1323 | 0.70 | 233 |
| | 7th heat input conditions | 180 | 0.30 | 1323 | 3.70 | 1233 |
| | 8th heat input conditions | 180 | 0.30 | 1323 | 0.70 | 233 |
| | 9th heat input conditions | 180 | 0.30 | 1323 | 0.70 | 233 |
| | 10th heat input conditions | 170 | 0.21 | 1016 | 3.70 | 1233 |
| | 11th heat input conditions | 170 | 0.21 | 1016 | 0.70 | 333 |
| | 12th heat input conditions | 170 | 0.21 | 1016 | 0.70 | 333 |
| | 13th heat input conditions | 170 | 0.21 | 1016 | 3.70 | 1762 |

As indicated in Table 3, all of the Examples achieved the desired bodies with sufficient joint strength were obtained without cracking or join discontinuities in the welded portion. Further, in all the Examples, excellent airtightness and in particular, excellent joint strength were obtained. Further, in Test No. 3-1, where the materials to be joined were not cooled, the bead width change ratio was 1.3, but in Test No. 3-2, where the materials to be joined were also not cooled, the widening of bead width as welding progressed was suppressed by satisfying (f) and (h) as described above, and a stainless steel and copper joined body having excellent bead width stability, in particular, was obtained. In Test No. 3-3, where the materials to be joined were cooled, the widening of the bead width was suppressed when compared to Test No. 3-1, where no cooling was performed. Further, in Test No. 3-4, where (f) and (h) were satisfied, as described above, along with cooling of the materials to be joined, the bead width spread was the smallest.

### Examples 4

Stainless steel tubes (welded tubes made from SUS304 stainless steel sheets as specified in JIS G 4305:2021) having an outer diameter of 10 mm, a thickness (wall thickness) of 0.5 mm, and a length of 300 mm, and copper tubes (phosphorous-deoxidized copper tubes (C1220T) as specified in JIS H 3300:2.018) having an outer diameter of 12 mm, a thickness (wall thickness) of 1.0 mm, and a length of 500 mm, were cut out, and the stainless steel tubes were inserted into the copper tubes so that a 5 mm length overlapped as the materials to be joined. Next, fillet welding by TIG welding was performed on the overlapping portion of materials to be joined, the stainless steel and the copper. Welding conditions were as listed in Tables 4 and 5. Further conditions were (a) electrode tilt angle: 0°, (b) electrode height: 1.0 mm, and (c) heat input point position: +1.0 mm. The heat input count was 13. This formed a fillet welded lap joint around the entire circumference, resulting in a joined body of the stainless steel tube and the copper tube. The welder used was Pipe Ace, a TIG welder manufactured by Matsumoto Kikai Co., Ltd. 100% Ar was used as the shielding gas and the back shielding gas at a gas flow rate of 25 L/min, respectively. Preflow was 5.0 s and postflow was 6.0 s. Conditions other than those described were in accordance with a conventional method. Cooling of the materials to be joined using a chill block or cooling tube was not performed.

Here, condition C in Table 4 is a set of conditions where none of (f) to (h) were satisfied, as described above, and the welding current, the welding time, and the heat input time interval for each heat input were constant. Further, condition D in Table 4 is a set of conditions where (g) was satisfied, condition E is a set of conditions where (f) was satisfied, condition F is a set of conditions where (h) was satisfied, condition G is a set of conditions where (f) and (g) were satisfied, condition H is a set of conditions where (g) and (h) were satisfied, and condition I is a set of conditions where (f), (g) and (h) were satisfied, as described above.

Using the joined bodies of the stainless steel sheets and the copper sheets, and the joined bodies of the stainless steel tubes and the copper tubes thus obtained, (d) the distance in the welding direction of each heat input point divided by the welding point diameter Dₖ₋₁, (I) the Cu/Fe ratio of the fillet welded lap joint, (II) the average diameter Dₘₑₐₙ, the minimum diameter Dₘᵢₙ, and the maximum diameter Dₘₐₓ of the welding points, and (III) the overlap ratio OR of the welding points were measured. The results are listed in Table 5.

Further, (IV) airtightness and (V) joint strength were measured as described above and evaluated according to the same criteria as in Examples 1. The results are listed in Table 5.

Further, the bead width change ratio (Dₘᵢₙ/Dₘₐₓ) was calculated from the minimum diameter Dₘᵢₙ and the maximum diameter Dₘₐₓ of the welding points. The results are listed in Table 5.

TABLE 5

| | Heat input conditions | | | | | | |
|---|---|---|---|---|---|---|---|
| | | (d) | | Joint | | | |
| | | | Distance in | | (II) | | |
| | | | welding direction | (I) | Average | Maximum | Minimum |
| | | Heat | of each heat input | Cu/Fe | diameter | diameter | diameter |
| | | input | point ÷ welding | ratio of | Dₘₑₐₙ of | Dₘₐₓ of | Dₘᵢₙ of |
| | Heat input | point | point diameter | filet | welding | welding | welding |
| Test | conditions | interval | Dₖ₋₁ | welded | points | points | points |
| No. | (Table 5) | (mm) | (%) | lap joint | (mm) | (mm) | (mm) |
| 4-1 | Condition C | 3.0 | 41~58 | 5.8 | 6.5 | 7.3 | 5.2 |
| 4-2 | Condition D | 3.0 | 49~58 | 8.0 | 5.7 | 6.1 | 5.2 |
| 4-3 | Condition E | 3.0 | 48~58 | 7.7 | 6.0 | 6.2 | 5.2 |
| 4-4 | Condition F | 3.0 | 50~58 | 9.4 | 5.6 | 6.0 | 5.2 |
| 4-5 | Condition G | 3.0 | 52~58 | 9.9 | 5.5 | 5.8 | 5.2 |
| 4-6 | Condition H | 3.0 | 54~58 | 10.8 | 5.3 | 5.6 | 5.2 |
| 4-7 | Condition I | 3.0 | 58 | 12.5 | 5.2 | 5.2 | 5.2 |

| | Joint | | | | | | |
|---|---|---|---|---|---|---|---|
| | | | (III) | Evaluation results | | | |
| | | | Overlap | | | (VI) | |
| | | | ratio OR | | | Bead | |
| | | | of welding | | (V) | width | |
| Test | | | points | (IV) | Joint | change | |
| No. | 2t^{0.5} | 10t^{0.5} | (%) | Airtightness | strength | ratio | Remarks |
| 4-1 | 2.0 | 10.0 | 54 | G | E | 1.4 | Example |
| 4-2 | 2.0 | 10.0 | 47 | G | E | 1.2 | Example |
| 4-3 | 2.0 | 10.0 | 50 | G | E | 1.2 | Example |
| 4-4 | 2.0 | 10.0 | 46 | G | E | 1.2 | Example |
| 4-5 | 2.0 | 10.0 | 45 | G | E | 1.1 | Example |
| 4-6 | 2.0 | 10.0 | 43 | G | E | 1.1 | Example |
| 4-7 | 2.0 | 10.0 | 42 | G | E | 1.0 | Example |

As indicated in Table 5, all of the Examples achieved the desired bodies with sufficient joint strength were obtained without cracking or join discontinuities in the welded portion. Further, in all the Examples, excellent airtightness and in particular, excellent joint strength were obtained. Further, in Test No. 4-2, 4-3, 4-4, 4-5, 4-6, and 4-7, at least one of (f) to (h) was satisfied, and accordingly, widening of the bead width as welding progressed was suppressed, and stainless steel and copper joined bodies having excellent bead width stability, in particular, were obtained.

### INDUSTRIAL APPLICABILITY

The stainless steel and copper joined body according to an embodiment of the present disclosure is suitable for application to various products, including heat exchanger pipes or tubes, electronic device components, and household appliances.

1. A stainless steel and copper joined body, comprising stainless steel, copper, and a fillet welded lap joint of the stainless steel and the copper, wherein
the stainless steel and the copper each have a sheet or tubular shape,
the fillet welded lap joint is formed at an end portion of the copper and the fillet welded lap joint includes multiple welding points that are continuous in a welding direction,
a Cu/Fe ratio of the fillet welded lap joint is 2.3 or more,
average diameter Dₘₑₐₙ (mm) of the welding points and copper thickness t (mm) satisfy the relationship of the following Formula (1),
$$2 {t}^{0.5} \leq {D}_{mean} \leq 10 {t}^{0.5} \qquad ( 1 )$$
and an overlap ratio OR of the welding points is 10% or more and 80% or less.

2. The stainless steel and copper joined body according to claim 1, wherein Dₘₐₓ/Dₘᵢₙ, a ratio of maximum diameter Dₘₐₓ (mm) to minimum diameter Dₘᵢₙ (mm) of the welding points, satisfies the relationship of the following Formula (2):
$${D}_{max} / {D}_{min} \leq 1.4 . \qquad ( 2 )$$

3. A stainless steel and copper joining method, wherein overlapping stainless steel and copper materials to be joined are joined by fillet welding,
the fillet welding is TIG welding,
the TIG welding comprises
positioning an electrode at a copper side of the overlapping portion of the materials to be joined, and performing multiple heat inputs under conditions satisfying (a) to (e) below,
(a) a tilt angle α of the electrode in a perpendicular-to-welding direction: −10° to +60°
here, the thickness direction of the materials to be joined is the reference angle (0°), and a side where a leading end of the electrode is pointed towards the copper side is +ve and a side where the leading end of the electrode is pointed towards the stainless steel side is −ve,
(b) electrode height: more than 0 mm and 3.0 mm or less
(c) each heat input position in the perpendicular-to-welding direction: 0 to +6×t (mm)
here, t is the copper thickness (mm), an end of the copper at the surface of the overlapping portion is the reference position (0), the copper side is +ve and the stainless steel side is −ve,
(d) distance interval in the welding direction between each heat input point: 20% or more to 90% or less of a diameter Dₖ₋₁ (mm) of a welding point formed by the immediately preceding heat input,
(e) time interval between each heat input: 20% or more of the welding time (s) of the immediately preceding heat input,
and further, at each heat input, welding current I (A), welding time d (s), and the copper thickness t (mm) satisfy the relationship of the following Formula (3):
$$500 \leq {I}^{1.5} \times {d}^{0.5} \times {t}^{- 1} \leq 3500. \qquad ( 3 )$$

4. The stainless steel and copper joining method according to claim 3, wherein at least one of conditions (f) to (h) below are satisfied:
(f) for each heat input, the welding current of the heat input is the welding current of the immediately preceding heat input or less;
(g) for each heat input, the welding time of the heat input is the welding time of the immediately preceding heat input or less; and
(h) a long heat input time interval is provided between some heat inputs.

5. A method of producing a stainless steel and copper joined body by joining stainless steel and copper by the stainless steel and copper joining method according to claim 3.

6. A method of producing a stainless steel and copper joined body by joining stainless steel and copper by the stainless steel and copper joining method according to claim 4.
